(19) United States
(12) Patent Application Publication
(10) Pub. No.: US 2025/0200894 A1
(43) Pub. Date: Jun. 19, 2025

(54) MODELING AND VISUALIZATION OF FACIAL STRUCTURE FOR DENTAL TREATMENT PLANNING

(71) Applicant: Align Technology, Inc., San Jose, CA (US)

(72) Inventors: Daniel Michel Peter, Uster (CH); Bernhard Steffen Thomaszewski, Zürich (CH); Niko Benjamin Huber, Zug (CH); Aleksandar Milojevic, Zürich (CH); Baran Gözcü, Greifensee (CH); Barbara Solenthaler, Zürich (CH); Alexandre Cavaleri, Lutry Vaud (CH); Michael Chang, Zürich (CH); Daniel Konrad Dorda, Zürich (CH); Doruk Cetin, Zürich (CH); Eric Paul Meyer, Zürich (CH)

(21) Appl. No.: 18/933,722

(22) Filed: Oct. 31, 2024

Related U.S. Application Data
(60) Provisional application No. 63/560,242, filed on Mar. 1, 2024.
(60) Provisional application No. 63/596,214, filed on Nov. 3, 2023.

(51) Int. Cl. G06T 17/20; G06T 13/40; G06V 40/16; H04N 9/73

(52) U.S. Cl. CPC G06T 17/20; G06T 13/40; G06V 40/171; H04N 9/73

(57) ABSTRACT

Methods and systems are described for 3D modeling and visualization of a patient's facial structure and features for dental treatment planning.

### CROSS-REFERENCE TO RELATED APPLICATION(S)

This application claims the benefit of priority of U.S. Provisional Patent Application No. 63/596,214, filed on Nov. 3, 2023, and of U.S. Provisional Patent Application No. 63/560,242, filed on Mar. 1, 2024, the disclosures of which are hereby incorporated by reference herein in their entireties.

### TECHNICAL FIELD

Embodiments of the present disclosure relate to the field of dentistry and, in particular, to 3D modeling and visualization of a patient's facial structure and features for dental treatment planning.

### BACKGROUND

A common objective of clinical interventions is to modify various structures of a patient's body, for example, to achieve improved performance and/or aesthetic appearance. In such instances, the goal of the clinician (e.g., doctor) is to take the patient from their current condition (initial state/condition) to a final condition (treatment outcome/goal). Depending on the type of procedure, there may be many ways to achieve the goal, e.g., through different implementations of a treatment plan. However, current methods fail to provide feedback to accurately predict or model aesthetic outcomes of such treatment plans.

### SUMMARY OF THE DISCLOSURE

The following presents a simplified summary of various aspects of the present disclosure in order to provide a basic understanding of such aspects. This summary is not an extensive overview of the disclosure. It is intended to neither identify key or critical elements of the disclosure, nor delineate any scope of the particular embodiments of the disclosure or any scope of the claims. Its sole purpose is to present some concepts of the disclosure in a simplified form as a prelude to the more detailed description that is presented later.

A first aspect of the present disclosure relates to a method of estimating a three-dimensional (3D) skull model representative of a patient's facial bone structure, the method comprising: receiving, or generating from a facial scan, a 3D skin model representative of an outer surface of the patient's head; generating a combined mesh comprising the 3D skin model and a candidate 3D skull model; generating a reprojected mesh from a trained machine learning model using the combined mesh as input; and generating the 3D skull model by removing the 3D skin model from the reprojected mesh.

A second aspect of the present disclosure relates to a method of estimating a 3D skull model representative of a patient's facial bone structure, the method comprising: receiving, or generating from a facial scan, a 3D skin model representative of an outer surface of the patient's head; projecting the 3D skin model into a learned skin latent space; applying a learned mapping from skin latent code to skull latent code to compute the corresponding coordinates in a learned skull latent space; and reprojecting the skull latent space coordinates back to the 3D skull model.

A third aspect of the present disclosure relates to a method of estimating a 3D skull model representative of a patient's facial bone structure, the method comprising: receiving, or generating from a facial scan, a 3D skin model representative of an outer surface of the patient's head; determining skin-bone model latent code by computing a fit according to a specified loss; and generating the 3D skull model from optimized joint skin-bone model fit.

A fourth aspect of the present disclosure relates to a method of training a machine learning model to predict skull structure of a patient based on a 3D skin model representative of an outer surface of the patient's skin, the method comprising: providing a plurality of data sets as training data, each data set corresponding to a particular patient and comprising at least a 3D skin model representative of an outer surface of the patient's skin and a 3D skull model representative of the patient's skull, wherein, during inference, the trained machine learning model is configured to compute a 3D skull model in response to a 3D skin model as input.

A fifth aspect of the present disclosure relates to a method of training a parametric head model that can be used with an optimization-based method to reconstruct a 3D skull model based on a patient's lateral cephalometric scan, wherein, during optimization, the parametric head model is fitted to an input cephalometric scan, and wherein joint head model latent code is optimized such that a rendered lateral/frontal projection is fitted to the input cephalometric scan.

A sixth aspect of the present disclosure relates to a method of generating a volumetric mesh representative of soft tissue of a patient's head, the method comprising: receiving, or generating from a facial scan, a 3D skin model representative of an outer surface of the patient's head; receiving intraoral scan data comprising a 3D teeth model representative of the patient's teeth and gingiva structure; receiving a 3D skull model representative of the patient's skull structure; generating, based at least partially on the 3D skin model, the 3D skull model, and the 3D teeth model, an initial unloaded volumetric mesh representative of an unloaded state of soft tissue of the patient's head under no teeth-soft contact or no gravitational load; and performing differentiable simulation-based optimization to optimize the unloaded volumetric mesh.

A seventh aspect of the present disclosure relates to a method of generating a photorealistic deformable 3D model of a patient's head via differentiable volumetric rendering modeling, the method comprising: receiving a plurality of two-dimensional (2D) images of the patient's head in different orientations; generating a differentiable volumetric rendering model based on the plurality of 2D images; and generating the photorealistic deformable 3D model based at least in part on the differentiable volumetric rendering model.

An eighth aspect of the present disclosure relates to a method of enhancing a 2D image of a patient's face, the method comprising: receiving the 2D image of the patient's face, wherein the patient's teeth are visible in the image; inputting the 2D image into a facial landmark detection model; inputting the 2D image into a facial semantic segmentation model; and inputting the output of each of the facial landmark detection model and the facial semantic segmentation model into a machine learning model configured to apply one or more image enhancements, wherein the machine learning model outputs an enhanced version of the 2D image.

A ninth aspect of the present disclosure relates to a method of computing an interpolated 2D image based on a first 2D image and a second 2D image of a patient's face, the method comprising: applying a color correction operation to the first 2D image and the second 2D image to perform color balancing between the first 2D image and the second 2D image, wherein the first 2D image corresponds to the patient's face in a neutral pose and the second 2D image corresponds to the patient's face in a wide smile pose for which the patient's teeth are substantially visible; and subsequently inputting the first 2D image and the second 2D image into a machine learning model trained to perform frame interpolation, wherein the output of the machine learning model comprises the interpolated 2D image. In at least one embodiment, a method of generating a series of interpolated 2D images generating a plurality of interpolated 2D images at different interpolation positions, wherein each of the plurality of interpolated 2D images is generated according to the method of the ninth aspect.

A tenth aspect of the present disclosure relates to a method of computing an interpolated 3D model based on a first 3D surface and a second 3D surface of a patient's face, the method comprising: registering the first 3D surface to a first 3D geometry and generating a first 2D texture map, the first 3D surface and first 3D geometry corresponding to the patient's face in a neutral pose; registering the second 3D surface to a second 3D geometry and generating a second 2D texture map, the second 3D surface and second 3D geometry corresponding to the patient's face in a wide smile pose for which the patient's teeth are substantially visible; computing an interpolated 2D image based on the first 2D texture map and the second 2D texture map; computing an interpolated 3D geometry based on the first 3D geometry and the second 3D geometry; and registering the interpolated 2D image to the interpolated 3D geometry to generate the interpolated 3D model.

A further aspect of the present disclosure relates to a system for estimating a 3D skull model representative of a patient's facial bone structure, the system comprising: a memory; and a processing device operatively coupled to the memory, wherein the processing device is configured to perform any one of the aforementioned methods.

A further aspect of the present disclosure relates to a non-transitory machine-readable medium having instructions encoded thereon that, when executed by a processing device, cause the processing device to perform any one of the aforementioned methods.

### BRIEF DESCRIPTION OF THE DRAWINGS

Embodiments of the present disclosure are illustrated by way of example, and not by way of limitation, in the figures of the accompanying drawings.

FIG. 1 illustrates an exemplary system for performing intraoral scanning and/or modeling or prediction of a patient's facial structure or features, in accordance with at least one embodiment.

FIG. 2 illustrates an exemplary modeling pipeline for generating 2D images and 3D models of a patient's head and facial features, in accordance with at least one embodiment.

FIG. 3 illustrates model training and inference for predicting skull structure, in accordance with at least one embodiment.

FIG. 4 illustrates an exemplary pipeline for predicting a 3D skull model of a patient, in accordance with at least one embodiment.

FIG. 5 is a flow diagram illustrating an exemplary method of estimating a 3D skull model representative of a patient's facial bone structure, in accordance with at least one embodiment.

FIG. 6 is a flow diagram illustrating an exemplary method of training a machine learning model to predict skull structure of a patient, in accordance with at least one embodiment

FIG. 7 illustrates an exemplary pipeline for generating a patient-specific volumetric mesh representative of soft tissue of a patient's head, in accordance with at least one embodiment.

FIG. 8 is a flow diagram illustrating exemplary method of generating a volumetric mesh representative of soft tissue of a patient's head, in accordance with at least one embodiment.

FIG. 9 is a flow diagram illustrating exemplary method of utilizing the volumetric mesh in treatment visualization, in accordance with at least one embodiment.

FIG. 10 illustrates an exemplary pipeline for generating photorealistic and deformable models, in accordance with at least one embodiment.

FIG. 11 illustrates the components of an exemplary neural radiance field architecture, in accordance with at least one embodiment.

FIG. 12 is a flow diagram illustrating an exemplary method of generating a photorealistic deformable 3D model of a patient's head via differentiable volumetric rendering modeling, in accordance with at least one embodiment.

FIG. 13 illustrates an exemplary pipeline for enhancing an 2D image, in accordance with at least one embodiment.

FIG. 14 illustrates an exemplary pipeline for performing image interpolation on 2D images, in accordance with at lease one embodiment.

FIG. 15 illustrates an exemplary pipeline for performing interpolation on 3D models, in accordance with at lease one embodiment.

FIG. 16 illustrates a variation of the exemplary pipeline for performing interpolation on 3D models, in accordance with at lease one embodiment.

FIG. 17 is a flow diagram illustrating an exemplary method of enhancing a 2D image of a patient's face, in accordance with at least one embodiment.

FIG. 18 is a method of computing an interpolated 2D image based on a first 2D image and a second 2D image of a patient's face, in accordance with at least one embodiment.

FIG. 19 is a method of computing an interpolated 3D model based on a first 3D surface and a second 3D surface of a patient's face, in accordance with at least one embodiment.

FIG. 20 illustrates a block diagram of an example computing device, in accordance with at least one embodiment.

### DETAILED DESCRIPTION

Described herein are methods and systems for the modeling and visualization of facial structure of a patient for use in dental treatment planning, outcome simulation, and evaluation.

Certain embodiments relate to a method of estimating or predicting a three-dimensional (3D) bone structure representative of a patient's facial bone structure based on a 3D mesh representative of the patient's skin surface. For example, in one embodiment, the method comprises receiving a 3D mesh data of a patient's face obtained from a face scan and using a machine learning algorithm to predict the shape and size of the patient's cranium and mandible based on shape of the face. In at least one embodiment, an aligned intraoral scan can be provided as an additional input to obtain a more accurate bone shape estimate. The embodiments advantageously provide a non-invasive approach to predict skull structure for dental, medical, and cosmetic purposes. The data can then be used for patient education, visualizations, animations of treatments, outcome visualization, and treatment planning. In at least one embodiment, a dataset of cone-beam computed tomography (CBCT) data can be used to train a machine learning algorithm used for the estimation or prediction of the 3D bone structure.

As used herein, the term “virtual patient” refers to a virtual representation of a patient or the patient's anatomy (e.g., a skin model, a skull model, a teeth model, other models, or combinations thereof) for which the virtual representation is generated from scan data associated with the patient. Further embodiments relate to a method of generating a volumetric mesh, such as a finite element mesh, that can be used for physically-based simulations (simulation mesh), representative of soft tissue of the virtual patient's head. For example, the method may receive a 3D skull model and 3D tooth models as input. The 3D skull model may be obtained from a CBCT scan, or may be predicted as described above. The 3D tooth models may be obtained from an intraoral scan. A volumetric mesh representative of the soft tissue of the patient's head may be generated based on a 3D skin model (obtained from a facial scan of the patient) and the 3D skull and 3D tooth models. The soft tissue attaches to the skull model in certain specified areas. Other areas of the skull may be specified to model a frictionless sliding contact interface between hard- and soft-tissues. One or more differentiable simulations are then performed to determine the volumetric mesh's shape when at rest, which is the shape in its unloaded state. An appropriate choice for the unloaded state can be when there are no contact forces acting on the lips from the teeth, similar to a toothless (edentulous) patient's condition. Optionally, the unloaded state, free of both teeth contact forces and gravitational load, can also be considered. The resulting unloaded volumetric mesh can be re-simulated under tooth contact forces and gravitational load to model the static equilibrium state of the patient's head under load, with soft-tissue in resting contact with the teeth and sliding-contact interfaces of the skull. Then, skull and teeth models can be modified (deformed and/or rigidly transformed) according to dental treatment plans or procedures to simulate resulting facial soft-tissue changes. The embodiments advantageously provide a more accurate representation of the patient's facial soft tissue for predicting the patient's facial shape and facial features post-treatment. This allows for improved visualization comprehensive dental treatment plans, and allows a clinician (e.g., doctor, orthodontist/restorative dentists/maxillofacial surgeon) to communicate the impact of treatment on the functional, aesthetic, structural, and long-term oral health goals for their patients.

Further embodiments relate to a method for photorealistic rendering of facial changes resulting from orthodontic, restorative and/or orthognathic surgery treatment. For example, in one embodiment, the method comprises receiving multiple images of a patient's face obtained from a facial scan and using a differentiable volumetric rendering method to optimize the appearance of the patient's face. Representative differentiable volumetric rendering methods may include, but are not limited to, radiance field methods (e.g., neural radiance field (NeRF), radiance field (RF), etc.) or 3D Gaussian splatting (3DGS). The embodiments advantageously provide a non-invasive approach to capture facial appearance and geometry for dental, medical, and cosmetic purposes. The data can then be used for patient education, visualizations, animations of treatments, outcome prediction, or treatment planning.

Further embodiments relate to methods of visually enhancing two-dimensional (2D) images and 3D models of a patient's face. For example, the methods may provide multiple approaches to enhancing simulated extra-oral visualizations/renderings of a patient's face to increase the aesthetic quality of the final visualization/rendering. In at least one embodiment, adjustments are applied as one or more modifications individually or in combination in image space (2D space) or 3D space. Such adjustments may included, but are not limited to: removal of temporary skin issues such as acne, pimples, or sunburns; reduction of wrinkles, relighting visualizations if captured in poorly-lit environments; removal of artefacts; deblurring of images or parts of images; upscaling operations; improvement of facial smile expression in a realistic manner; and addition of visual consistency to captured 2D extra-oral images and 3D facial scans. These embodiments advantageously improve the final quality of visualizations/renderings within a treatment plan visualization pipeline, thus increasing patient conversion as well as providing cosmetic outcome treatments simultaneously with dental treatment planning.

These embodiments and others are further described herein, and various combinations thereof are contemplated. It should be understood that these various embodiments may be implemented as stand-alone solutions and/or may be combined. Accordingly, references to an embodiment, or one embodiment, may refer to the same embodiment and/or to different embodiments. Moreover, the embodiments herein are not limited to the skull, facial features, or facial soft tissue of a patient, and could be adapted to modeling and predicting information related to other portions of a patient's body. Some embodiments are discussed herein with reference to intraoral scans and intraoral images. However, it should be understood that embodiments described with reference to intraoral scans also apply to lab scans or model/impression scans. A lab scan or model/impression scan may include one or more images of a dental site or of a model or impression of a dental site, which may or may not include height maps, and which may or may not include color images.

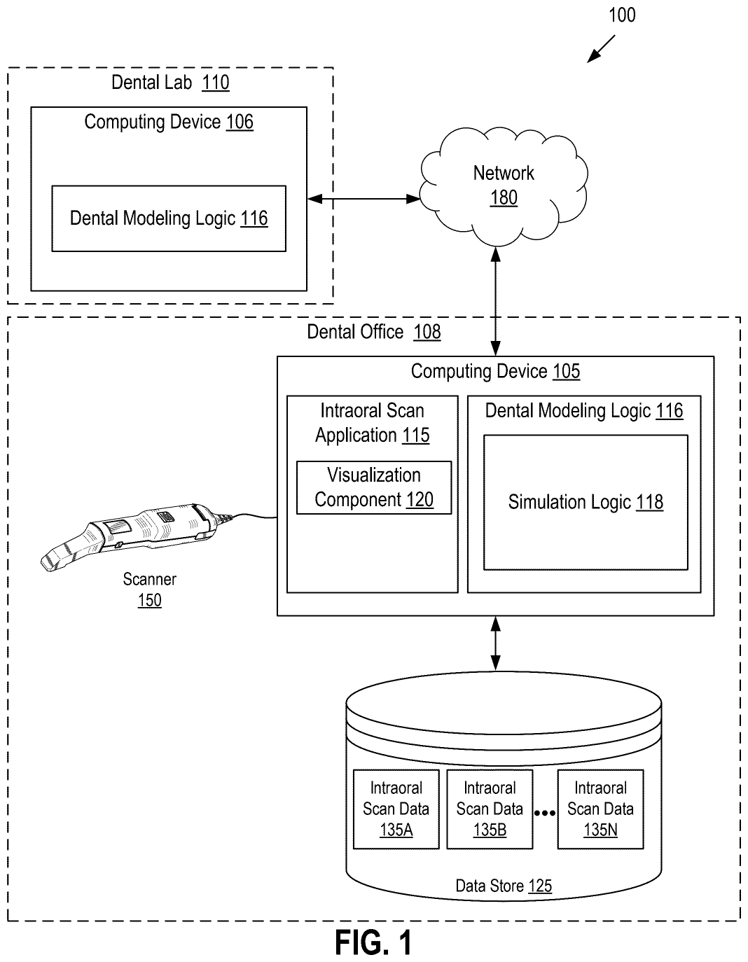

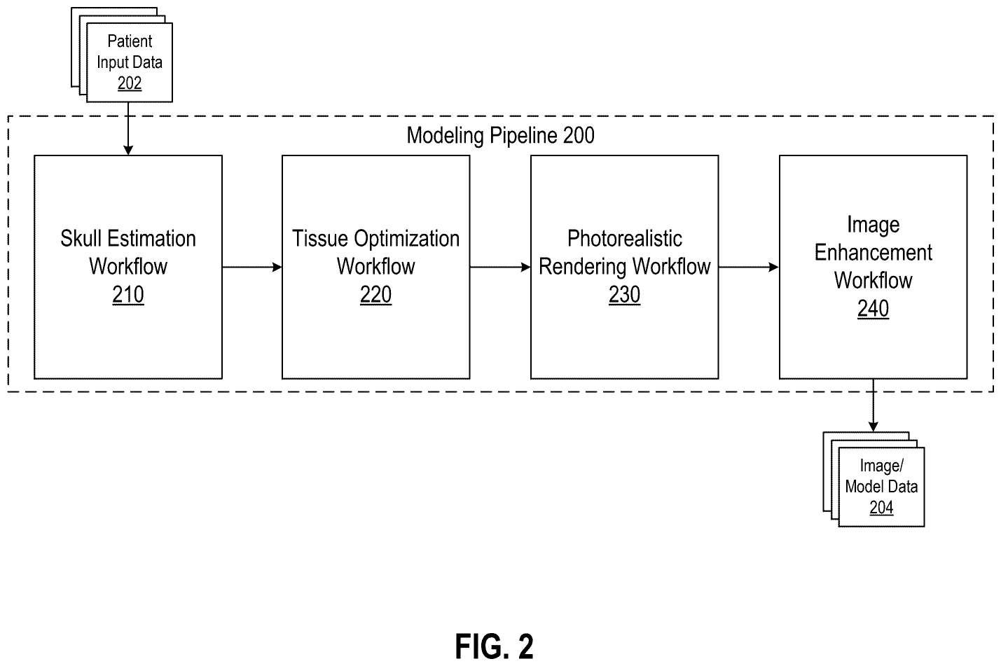

FIG. 1 illustrates an exemplary system 100 for performing intraoral scanning and/or modeling and visualization of facial structure for dental treatment planning, in accordance with at least one embodiment. In at least one embodiment, one or more components of system 100 carries out one or more operations of the workflows, pipelines, methods, and algorithms discussed below with respect to FIGS. 2-19.

System 100 includes a dental office 108 and a dental lab 110. The dental office 108 and the dental lab 110 each include a computing device 105, 106, where the computing devices 105, 106 may be connected to one another via a network 180. The network 180 may be a local area network (LAN), a public wide area network (WAN) (e.g., the Internet), a private WAN (e.g., an intranet), or a combination thereof.

Computing device 105 may be coupled to an intraoral scanner 150 (also referred to as a scanner) and/or a data store 125. Computing device 106 may also be connected to a data store (not shown). The data stores may be local data stores and/or remote data stores. Computing device 105 and computing device 106 may each include one or more processing devices, memory, secondary storage, one or more input devices (e.g., such as a keyboard, mouse, tablet, and so on), one or more output devices (e.g., a display, a printer, etc.), and/or other hardware components.

In at least one embodiment, scanner 150 is wirelessly connected to computing device 105 via a direct wireless connection. In at least one embodiment, scanner 150 is wirelessly connected to computing device 105 via a wireless network. In at least one embodiment, the wireless network is a Wi-Fi network. In at least one embodiment, the wireless network is a Bluetooth network, a Zigbee network, or some other wireless network. In at least one embodiment, the wireless network is a wireless mesh network, examples of which include a Wi-Fi mesh network, a Zigbee mesh network, and so on. In an example, computing device 105 may be physically connected to one or more wireless access points and/or wireless routers (e.g., Wi-Fi access points/routers). Intraoral scanner 150 may include a wireless module such as a Wi-Fi module, and via the wireless module may join the wireless network via the wireless access point/router.

In at least one embodiment, scanner 150 includes an inertial measurement unit (IMU). The IMU may include an accelerometer, a gyroscope, a magnetometer, a pressure sensor and/or other sensor. For example, scanner 150 may include one or more micro-electromechanical system (MEMS) IMU. The IMU may generate inertial measurement data (referred to herein as movement data or motion data), including acceleration data, rotation data, and so on.

Intraoral scanner 150 may include a probe (e.g., a hand held probe) for optically capturing three-dimensional structures. The intraoral scanner 150 may be used to perform an intraoral scan of a patient's oral cavity, in which a plurality of intraoral scans (also referred to as intraoral images) are generated. An intraoral scan application 115 running on computing device 105 may communicate with the scanner 150 to effectuate the intraoral scanning process. A result of the intraoral scanning may be intraoral scan data 135A, 135B through 135N that may include one or more sets of intraoral scans or intraoral images. Each intraoral scan or image may include a 2D image that includes depth information (e.g., via a height map of a portion of a dental site) and/or may include a 3D point cloud. In either case, each intraoral scan includes x, y and z information. Some intraoral scans, such as those generated by confocal scanners, include 2D height maps. In at least one embodiment, the intraoral scanner 150 generates numerous discrete (i.e., individual) intraoral scans. Sets of discrete intraoral scans may be merged into a smaller set of blended intraoral scans, where each blended intraoral scan is a combination of multiple discrete intraoral scans. Intraoral scan data 135A-N may optionally include one or more color images (e.g., color 2D images) and/or images generated under particular lighting conditions (e.g., 2D ultraviolet (UV) images, 2D infrared (IR) images, 2D near-IR images, 2D fluorescent images, and so on).

The scanner 150 may transmit the intraoral scan data 135A, 135B through 135N to the computing device 105. Computing device 105 may store the intraoral scan data 135A-135N in data store 125. The computing device 105 may further store other data representative of a patient, including CBCT scan data, facial imaging data, facial scan data, etc. in the data store 125.

According to an example, a user (e.g., a practitioner) may subject a patient to intraoral scanning. In doing so, the user may apply scanner 150 to one or more patient intraoral locations. The scanning may be divided into one or more segments. As an example, the segments may include an upper dental arch segment, a lower dental arch segment, a bite segment, and optionally one or more preparation tooth segments. As another example, the segments may include a lower buccal region of the patient, a lower lingual region of the patient, an upper buccal region of the patient, an upper lingual region of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient's mouth with the scan being directed towards an interface area of the patient's upper and lower teeth). Via such scanner application, the scanner 150 may provide intraoral scan data 135A-N to computing device 105. The intraoral scan data 135A-N may be provided in the form of intraoral scan data sets, each of which may include 3D point clouds, 2D scans/images and/or 3D scans/images of particular teeth and/or regions of an intraoral site. In at least one embodiment, separate data sets are created for the maxillary arch, for the mandibular arch, for a patient bite, and for each preparation tooth. Alternatively, a single large data set is generated (e.g., for a mandibular and/or maxillary arch). Such scans may be provided from the scanner 150 to the computing device 105 in the form of one or more points (e.g., one or more point clouds).

The manner in which the oral cavity of a patient is to be scanned may depend on the procedure to be applied thereto. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Additionally, the manner in which the oral cavity is to be scanned may depend on a doctor's scanning preferences and/or patient conditions.

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity (intraoral site), or a real or virtual model thereof, or directed to the design and preparation of the intraoral site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture or installation of orthodontic elements at a intraoral site within the oral cavity, or a real or virtual model thereof, or directed to the design and preparation of the intraoral site to receive such orthodontic elements. These elements may be appliances including but not limited to brackets and wires, retainers, clear aligners, or functional appliances.

During intraoral scanning, intraoral scan application 115 may register and stitch together two or more intraoral scans (e.g., intraoral scan data 135A and intraoral scan data 135B) generated thus far from the intraoral scan session. In at least one embodiment, performing registration includes capturing 3D data of various points of a surface in multiple scans, and registering the scans by computing transformations between the scans. One or more 3D surfaces may be generated based on the registered and stitched together intraoral scans during the intraoral scanning. The one or more 3D surfaces may be output to a display so that a doctor or technician can view their scan progress thus far.

As each new intraoral scan is captured and registered to previous intraoral scans and/or a 3D surface, the one or more 3D surfaces may be updated, and the updated 3D surface(s) may be output to the display. In at least one embodiment, segmentation is performed on the intraoral scans and/or the 3D surface to segment points and/or patches on the intraoral scans and/or 3D surface into one or more classifications. In at least one embodiment, intraoral scan application 115 classifies points as hard tissue or as soft tissue. The 3D surface may then be displayed using the classification information. For example, hard tissue may be displayed using a first visualization (e.g., an opaque visualization) and soft tissue may be displayed using a second visualization (e.g., a transparent or semi-transparent visualization).

In at least one embodiment, separate 3D surfaces are generated for the upper jaw and the lower jaw. This process may be performed in real time or near-real time to provide an updated view of the captured 3D surfaces during the intraoral scanning process.

When a scan session or a portion of a scan session associated with a particular scanning role or segment (e.g., upper jaw role, lower jaw role, bite role, etc.) is complete (e.g., all scans for an intraoral site or dental site have been captured), intraoral scan application 115 may automatically generate a virtual 3D model of one or more scanned dental sites (e.g., of an upper jaw and a lower jaw). The final 3D model may be a set of 3D points and their connections with each other (i.e., a mesh). In at least one embodiment, the final 3D model is a volumetric 3D model that has both surface and internal features. In at least one embodiment, the 3D model is a volumetric model generated as described in International Patent Application Publication No. WO 2019/147984 A1, entitled “Diagnostic Intraoral Scanning and Tracking,” which is hereby incorporated by reference herein in its entirety.

To generate the virtual 3D model, intraoral scan application 115 may register and stitch together the intraoral scans generated from the intraoral scan session that are associated with a particular scanning role or segment. The registration performed at this stage may be more accurate than the registration performed during the capturing of the intraoral scans, and may take more time to complete than the registration performed during the capturing of the intraoral scans. In at least one embodiment, performing scan registration includes capturing 3D data of various points of a surface in multiple scans, and registering the scans by computing transformations between the scans. The 3D data may be projected into a 3D space of a 3D model to form a portion of the 3D model. The intraoral scans may be integrated into a common reference frame by applying appropriate transformations to points of each registered scan and projecting each scan into the 3D space.

In at least one embodiment, registration is performed for adjacent or overlapping intraoral scans (e.g., each successive frame of an intraoral video). In at least one embodiment, registration is performed using blended scans. Registration algorithms are carried out to register two adjacent or overlapping intraoral scans (e.g., two adjacent blended intraoral scans) and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, intraoral scan application 115 may match points of one scan with the closest points interpolated on the surface of another scan, and iteratively minimize the distance between matched points. Other registration techniques may also be used.

Intraoral scan application 115 may repeat registration for all intraoral scans of a sequence of intraoral scans to obtain transformations for each intraoral scan, to register each intraoral scan with previous intraoral scan(s) and/or with a common reference frame (e.g., with the 3D model). Intraoral scan application 115 may integrate intraoral scans into a single virtual 3D model by applying the appropriate determined transformations to each of the intraoral scans. Each transformation may include rotations about one to three axes and translations within one to three planes.

In many instances, data from one or more intraoral scans does not perfectly correspond to data from one or more other intraoral scans. Accordingly, in at least one embodiment, intraoral scan application 115 may process intraoral scans (e.g., which may be blended intraoral scans) to determine which intraoral scans (or which portions of intraoral scans) to use for portions of a 3D model (e.g., for portions representing a particular dental site). Intraoral scan application 115 may use data such as geometric data represented in scans and/or time stamps associated with the intraoral scans to select optimal intraoral scans to use for depicting a dental site or a portion of a dental site. In at least one embodiment, images are input into a machine learning model that has been trained to select and/or grade scans of dental sites. In at least one embodiment, one or more scores are assigned to each scan, where each score may be associated with a particular dental site and indicate a quality of a representation of that dental site in the intraoral scans.

Additionally, or alternatively, intraoral scans may be assigned weights based on scores assigned to those scans (e.g., based on proximity in time to a time stamp of one or more selected 2D images). Assigned weights may be associated with different dental sites. In at least one embodiment, a weight may be assigned to each scan (e.g., to each blended scan) for a dental site (or for multiple dental sites). During model generation, conflicting data from multiple intraoral scans may be combined using a weighted average to depict a dental site. The weights that are applied may be those weights that were assigned based on quality scores for the dental site. For example, processing logic may determine that data for a particular overlapping region from a first set of intraoral scans is superior in quality to data for the particular overlapping region of a second set of intraoral scans. The first intraoral scan data set may then be weighted more heavily than the second intraoral scan data set when averaging the differences between the intraoral scan data sets. For example, the first intraoral scans assigned the higher rating may be assigned a weight of 70% and the second intraoral scans may be assigned a weight of 30%. Thus, when the data is averaged, the merged result will look more like the depiction from the first intraoral scan data set and less like the depiction from the second intraoral scan data set.

In at least one embodiment, images and/or intraoral scans are input into a machine learning model that has been trained to select and/or grade images and/or intraoral scans of dental sites. In at least one embodiment, one or more scores are assigned to each image and/or intraoral scan, where each score may be associated with a particular dental site and indicate a quality of a representation of that dental site in the 2D image and/or intraoral scan. Once a set of images is selected for use in generating a portion of a 3D model/surface that represents a particular dental site (or a portion of a particular dental site), those images/scans and/or portions of those images/scans may be locked. Locked images or portions of locked images that are selected for a dental site may be used exclusively for creation of a particular region of a 3D model (e.g., for creation of the associated tooth in the 3D model).

Intraoral scan application 115 may generate one or more 3D surfaces and/or 3D models from intraoral scans, and may display the 3D surfaces and/or 3D models to a user (e.g., a doctor) via a user interface. The 3D surfaces and/or 3D models can then be checked visually by the doctor. The doctor can virtually manipulate the 3D surfaces and/or 3D models via the user interface with respect to up to six degrees of freedom (i.e., translated and/or rotated with respect to one or more of three mutually orthogonal axes) using suitable user controls (hardware and/or virtual) to enable viewing of the 3D model from any desired direction. The doctor may review (e.g., visually inspect) the generated 3D surface and/or 3D model of an intraoral site and determine whether the 3D surface and/or 3D model is acceptable.

Once a 3D model of a dental site (e.g., of a dental arch or a portion of a dental arch including a preparation tooth) is generated, it may be sent to dental modeling logic 116 for review, analysis and/or updating. Additionally, or alternatively, one or more operations associated with review, analysis and/or updating of the 3D model may be performed by intraoral scan application 115.

Intraoral scan application 115 and/or dental modeling logic 116 may include simulation logic 118 for simulating, predicting, or generating 3D models representative of a patient's bone structure or soft tissue, which may be used for downstream modeling and or dental treatment planning. The simulation logic 118 may be, for example, a component of an intraoral scanning apparatus that includes a handheld intraoral scanner (e.g., the scanner 150) and a computing device operatively coupled (e.g., via a wired or wireless connection) to the handheld intraoral scanner. Alternatively, or additionally, the dental modeling application may execute on a computing device at a dentist office or dental lab.

The simulation logic 118 may be used to perform any of the operations described with respect to FIGS. 2-19.

In at least one embodiment, a visualization component 120 of the intraoral scan application 115 may be used to visualize resulting 3D models for inspection, labeling, patient education, or any other purpose. In at least one embodiment, the visualization component 120 may be utilized to compare 3D representations of a patient's face and head generated based on intraoral scan data and other types of scan data (e.g., 3D face scan data, CBCT scan data, etc.) at various stages of a treatment plan. Such embodiments allow for visualization of hard- and soft-tissue changes to the patient's facial appearance as a result of tooth movement and shifting.

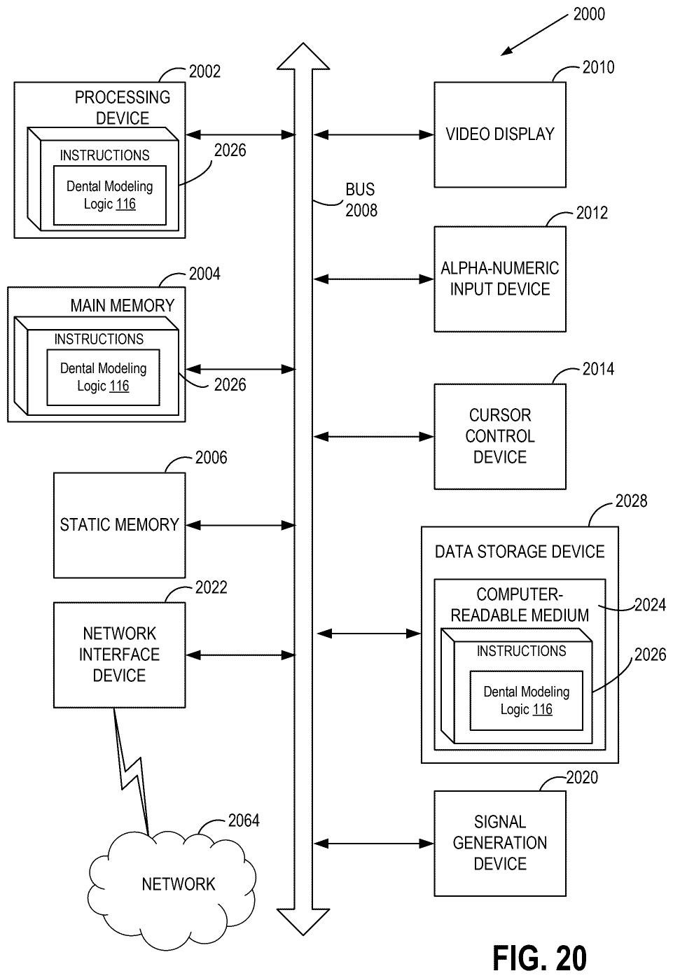

In various embodiments, modeling and estimation in accordance with the embodiments described herein (e.g., hard tissue estimation, soft tissue estimation and optimization, simulating tissue deformations, applying deformations to photorealistic facial meshes, modifying facial images, etc.) may be performed using one or more trained machine learning models. In at least one embodiment, one or more workflows may be utilized to implement model training (referred to as a “model training workflow”) in accordance with embodiments of the present disclosure. In various embodiments, the model training workflow may be performed at a server which may or may not include an intraoral scan application. The model training workflow and the model application workflow may be performed by processing logic executed by a processor of a computing device. One or more of these workflows may be implemented, for example, by one or more machine learning modules implemented in an intraoral scan application 115, by dental modeling logic 116, or other software and/or firmware executing on a processing device of computing device 2000 shown and described in FIG. 20.

The model training workflow is to train one or more machine learning models (e.g., deep learning models) to perform one or more classification, segmentation, regression, detection, recognition, prediction, etc. tasks for intraoral scan data (e.g., 3D intraoral scans, height maps, 2D color images, 2D NIRI images, 2D fluorescent images, etc.), 3D surfaces generated based on intraoral scan data, and/or 3D meshes or volumetric data descriptive of a patient's bone structure and/or facial structure/features. The model application workflow is to apply the one or more trained machine learning models to perform the classification, segmentation, regression, detection, recognition, prediction, etc. tasks for intraoral scan data (e.g., 3D scans, height maps, 2D color images, NIRI images, etc.) and/or 3D surfaces generated based on intraoral scan data. One or more of the machine learning models may receive and process 3D data (e.g., 3D point clouds, 3D surfaces, portions of 3D models, etc.). One or more of the machine learning models may receive and process 2D data (e.g., height maps, projections of 3D surfaces onto planes, etc.).

Many different machine learning outputs are described herein. Particular numbers and arrangements of machine learning models are described. However, it should be understood that the number and type of machine learning models that are used and the arrangement of such machine learning models can be modified to achieve the same or similar end results. Accordingly, the arrangements of machine learning models that are described and shown are merely examples and should not be construed as limiting.

In various embodiments, one or more machine learning models are trained to perform one or more of the below tasks. Each task may be performed by a separate machine learning model. Alternatively, a single machine learning model may perform each of the tasks or a subset of the tasks. Additionally, or alternatively, different machine learning models may be trained to perform different combinations of the tasks. In an example, one or a few machine learning models may be trained, where the trained ML model is a single shared neural network that has multiple shared layers and multiple higher level distinct output layers, where each of the output layers outputs a different prediction, classification, identification, etc. The tasks that the one or more trained machine learning models may be trained to perform are, but not limited to, the following:
I) Canonical position determination—this can include determining canonical position and/or orientation of a 3D surface or of objects in an intraoral scan, or determining canonical positions of objections in a 2D image.
II) Scan/2D image assessment—this can include determining quality metric values associated with intraoral scans, 2D images and/or regions of 3D surfaces. This can include assigning a quality value to individual scans, 3D surfaces, portions of 3D surface, 3D models, portions of 3D models, 2D images, portions of 2D images, etc.
III) Moving tissue (excess tissue) identification/removal—this can include performing pixel-level identification/classification of moving tissue (e.g., tongue, finger, lips, etc.) from intraoral scans and/or 2D images and optionally removing such moving tissue from intraoral scans, 2D images and/or 3D surfaces. Moving tissue identification and removal is described in U.S. Patent Application Publication No. 2020/0349698 A1, entitled “Excess Material Removal Using Machine Learning,” which is hereby incorporated by reference herein in its entirety.
IV) Dental features in 2D or 3D images—this can include performing point-level or pixel-level classification of 3D models and/or 2D images to classify points/pixels as being part of dental features. This can include performing segmentation of 3D surfaces and/or 2D images. Points/pixels may be classified into two or more classes. A minimum classification taxonomy may include a dental feature class and a not dental feature class. In other examples, further dental classes may be identified, such as a hard tissue or tooth class, a soft tissue or gingiva class, and a margin line class.

One type of machine learning model that may be used to perform some or all of the above asks is an artificial neural network, such as a deep neural network. Artificial neural networks generally include a feature representation component with a classifier or regression layers that map features to a desired output space. A convolutional neural network (CNN), for example, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). Deep learning is a class of machine learning algorithms that use a cascade of multiple layers of nonlinear processing units for feature extraction and transformation. Each successive layer uses the output from the previous layer as input. Deep neural networks may learn in a supervised (e.g., classification) and/or unsupervised (e.g., pattern analysis) manner. Deep neural networks include a hierarchy of layers, where the different layers learn different levels of representations that correspond to different levels of abstraction. In deep learning, each level learns to transform its input data into a slightly more abstract and composite representation. In an image recognition application, for example, the raw input may be a matrix of pixels; the first representational layer may abstract the pixels and encode edges; the second layer may compose and encode arrangements of edges; the third layer may encode higher level shapes (e.g., teeth, lips, gums, etc.); and the fourth layer may recognize a scanning role. Notably, a deep learning process can learn which features to optimally place in which level on its own. The “deep” in “deep learning” refers to the number of layers through which the data is transformed. More precisely, deep learning systems have a substantial credit assignment path (CAP) depth. The CAP is the chain of transformations from input to output. CAPs describe potentially causal connections between input and output. For a feedforward neural network, the depth of the CAPs may be that of the network and may be the number of hidden layers plus one. For recurrent neural networks, in which a signal may propagate through a layer more than once, the CAP depth is potentially unlimited.

In one embodiment, a deep learning model that performs whitening and color transfers (WCT) is used, such as for a color transfer module. The model may be trained to perform a photorealistic style transfer between images that are to be merged to form a video. The model may recover the structural information of a given content image while it stylizes the image faithfully (e.g., based on a second input image) at the same time. In one embodiment, the model performs a wavelet corrected transfer based on Whitening and Coloring Transforms (WCT). WCT can perform style transfer with arbitrary styles by directly matching the correlation between content and style in a visual geometry group (VGG) feature domain. The model may project the content features to the eigenspace of style features by calculating singular value decomposition (SVD). The final stylized image may be obtained by feeding the transferred features into a decoder. In at least one embodiment, a multi-level stylization framework is employed that applies WCT to multiple encoder-decoder pairs.

In one embodiment, a pose estimation model is used to perform landmark detection, and to essentially detect the pose of a patient's face and/or teeth in images, such as for a landmark detection module. In one embodiment, the pose estimation model is a convolutional neural network that includes multiple stacked hourglass neural network modules end-to-end. This allows for repeated bottom-up, top-down inference across scales.

In one embodiment, a generative model is used for one or more machine learning models. The generative model may be a generative adversarial network (GAN), encoder/decoder model, diffusion model, variational autoencoder (VAE), or other types of generative models. In addition to these generative models, a differentiable volumetric rendering approach (such as NeRF, RF, 3DGS) may also be used, which is especially effective for synthesizing novel views of complex 3D scenes. These may be used, for example, in an image generation module.

A GAN is a class of artificial intelligence system that uses two artificial neural networks contesting with each other in a zero-sum game framework. The GAN includes a first artificial neural network that generates candidates and a second artificial neural network that evaluates the generated candidates. The GAN learns to map from a latent space to a particular data distribution of interest (a data distribution of changes to input images that are indistinguishable from photographs to the human eye), while the discriminative network discriminates between instances from a training dataset and candidates produced by the generator. The generative network's training objective is to increase the error rate of the discriminative network (e.g., to fool the discriminator network by producing novel synthesized instances that appear to have come from the training dataset). The generative network and the discriminator network are co-trained, and the generative network learns to generate images that are increasingly more difficult for the discriminative network to distinguish from real images (from the training dataset) while the discriminative network at the same time learns to be better able to distinguish between synthesized images and images from the training dataset. The two networks of the GAN are trained once they reach equilibrium. The GAN may include a generator network that generates artificial intraoral images and a discriminator network that attempts to differentiate between real images and artificial intraoral images. In at least one embodiment, the discriminator network may be a MobileNet.

In at least one embodiment, a generative model that is used is a generative model trained to perform frame interpolation—synthesizing intermediate images between a pair of input frames or images. The generative model may receive a pair of input images, and generate an intermediate image that can be placed in a video between the pair of images, such as for frame rate upscaling. In one embodiment, the generative model has three main stages, including a shared feature extraction stage, a scale-agnostic motion estimation stage, and a fusion stage that outputs a resulting color image. The motion estimation stage in at least one embodiment is capable of handling a time-wise non-regular input data stream. Feature extraction may include determining a set of features of each of the input images in a feature space, and the scale-agnostic motion estimation may include determining an optical flow between the features of the two images in the feature space. The optical flow and data from one or both of the images may then be used to generate the intermediate image in the fusion stage. The generative model may be capable of stable tracking of features without artifacts for large motion. The generative model may handle disocclusions in at least one embodiment. Additionally the generative model may provide improved image sharpness as compared to traditional techniques for image interpolation. In at least one embodiment, the generative model generates simulated images recursively. The number of recursions may not be fixed, and may instead be based on metrics computed from the images.

In one embodiment, one or more machine learning model is a conditional generative adversarial (cGAN) network, such as pix2pix. These networks not only learn the mapping from input image to output image, but also learn a loss function to train this mapping. GANs are generative models that learn a mapping from random noise vector z to output image y, G: z→y. In contrast, conditional GANs learn a mapping from observed image x and random noise vector z, to y, G: {x, z}→y. The generator G is trained to produce outputs that cannot be distinguished from “real” images by an adversarially trained discriminator, D, which is trained to do as well as possible at detecting the generator's “fakes”. The generator may include a U-net or encoder-decoder architecture in at least one embodiment. The discriminator may include a MobileNet architecture in at least one embodiment. An example of a cGAN machine learning architecture that may be used is the pix2pix architecture described in Isola, Phillip, et al. “Image-to-image translation with conditional adversarial networks.” arXiv preprint (2017).

In one embodiment, one or more machine learning model that is used to generate replacement images is a StyleGAN. StyleGAN is an extension to a GAN architecture to give control over disentangled style properties of generated images. In at least one embodiment, a generative network is a generative adversarial network (GAN) that includes a generator model and a discriminator model, where a generator model includes use of a mapping network to map points in latent space to an intermediate latent space, includes use of the intermediate latent space to control style at each point in the generator model, and uses introduction of noise as a source of variation at one or more points in the generator model. A resulting generator model is capable not only of generating impressively photorealistic high-quality synthetic images, but also offers control over a style of generated images at different levels of detail through varying style vectors and noise. Each style vector may correspond to a parameter or feature of clinical information or a parameter or feature of non-clinical information. For example, there may be one style vector for camera viewpoint or face pose, one style vector for lighting, one style vector for patient clothing, one style vector for attachments, one style vector for facial expression, and so on in at least one embodiment. In at least one embodiment, a generator starts from a learned constant input and adjusts a “style” of an image at each convolution layer based on a latent code, therefore directly controlling a strength of image features at different scales.

In at least one embodiment, a StyleGAN generator uses two sources of randomness to generate a synthetic image: a standalone mapping network and noise layers, in addition to a starting point from latent space. An output from a mapping network is a vector that defines styles that is integrated at each point in a generator model via a layer called adaptive instance normalization. Use of this style vector gives control over style of a generated image. In at least one embodiment, stochastic variation is introduced through noise added at each point in a generator model. Noise may be added to entire feature maps that allow a model to interpret a style in a fine-grained, per-pixel manner. This per-block incorporation of style vector and noise allows each block to localize both an interpretation of style and a stochastic variation to a given level of detail.

In at least one embodiment, a graph neural network (GNN) architecture is used that operates on three-dimensional data. Unlike a traditional neural network that operates on two-dimensional data, the GNN may receive three-dimensional data (e.g., 3D surfaces) as inputs, and may output predictions, estimates, classifications, etc. based on the three-dimensional data.

In at least one embodiment, a U-net architecture is used for one or more machine learning model. A U-net is a type of deep neural network that combines an encoder and decoder together, with appropriate concatenations between them, to capture both local and global features. The encoder is a series of convolutional layers that increase the number of channels while reducing the height and width when processing from inputs to outputs, while the decoder increases the height and width and reduces the number of channels. Layers from the encoder with the same image height and width may be concatenated with outputs from the decoder. Any or all of the convolutional layers from encoder and decoder may use traditional or depth-wise separable convolutions.

In at least one embodiment, one or more machine learning model is a recurrent neural network (RNN). An RNN is a type of neural network that includes a memory to enable the neural network to capture temporal dependencies. An RNN is able to learn input-output mappings that depend on both a current input and past inputs. The RNN will address past and future scans and make predictions based on this continuous scanning information. RNNs may be trained using a training dataset to generate a fixed number of outputs (e.g., to classify time varying data such as video data as belonging to a fixed number of classes). One type of RNN that may be used is a long short term memory (LSTM) neural network.

A common architecture for such tasks is LSTM (Long Short Term Memory). Generally, LSTM is not as well suited for images since it does not capture spatial information as well as convolutional networks do. For this purpose, one can utilize ConvLSTM—a variant of LSTM containing a convolution operation inside the LSTM cell. ConvLSTM is a variant of LSTM (Long Short-Term Memory) containing a convolution operation inside the LSTM cell. ConvLSTM replaces matrix multiplication with a convolution operation at each gate in the LSTM cell. By doing so, it captures underlying spatial features by convolution operations in multiple-dimensional data. The main difference between ConvLSTM and LSTM is the number of input dimensions. As LSTM input data is one-dimensional, it is not suitable for spatial sequence data such as video, satellite, radar image data set. ConvLSTM is designed for 3-D data as its input. In at least one embodiment, a CNN-LSTM machine learning model is used. A CNN-LSTM is an integration of a CNN (Convolutional layers) with an LSTM. First, the CNN part of the model processes the data and a one-dimensional result feeds an LSTM model.

Training of a neural network may be achieved in a supervised learning manner, which involves feeding a training dataset consisting of labeled inputs through the network, observing its outputs, defining an error (by measuring the difference between the outputs and the label values), and using techniques such as deep gradient descent and backpropagation to tune the weights of the network across all its layers and nodes such that the error is minimized. In many applications, repeating this process across the many labeled inputs in the training dataset yields a network that can produce correct output when presented with inputs that are different than the ones present in the training dataset. In high-dimensional settings, such as large images, this generalization is achieved when a sufficiently large and diverse training dataset is made available.

For the model training workflow, a training dataset containing hundreds, thousands, tens of thousands, hundreds of thousands or more intraoral scans, and/or 3D models can be used. In at least one embodiment, up to millions of cases of patient dentition that may have underwent a prosthodontic procedure and/or an orthodontic procedure may be available for forming a training dataset, where each case may include various labels of one or more types of useful information. Each case may include, for example, data showing a 3D model, intraoral scans, height maps, color images, NIRI images, etc. of one or more dental sites, data showing pixel-level segmentation of the data (e.g., 3D model, intraoral scans, height maps, color images, NIRI images, etc.) into various dental classes (e.g., tooth, gingiva, moving tissue, saliva, blood, etc.), data showing one or more assigned scan quality metric values for the data, movement data associated with the 3D scans, and so on. This data may be processed to generate one or multiple training datasets for training of one or more machine learning models.

To effectuate training, processing logic inputs the training dataset(s) into one or more untrained machine learning models. Prior to inputting a first input into a machine learning model, the machine learning model may be initialized. Processing logic trains the untrained machine learning model(s) based on the training dataset(s) to generate one or more trained machine learning models that perform various operations as set forth above.

For example, for bone structure estimation, training may be performed by inputting a 3D skull mesh, an associated skin mesh registered with the skull into the machine learning model. Each input may include data from various scans associated with a patient, including an intraoral scan, cephalometric X-ray, panoramic X-ray, CBCT, or 3D surface from the training dataset. The training data item may include, for example, a height map, 3D point cloud, 3D volumetric data (e.g., CBCT density), or 2D image and an associated probability map, which may be input into the machine learning model. As another example, for generating a photorealistic deformable 3D model of a patient's head using a differentiable volumetric rendering approach (e.g., radiance-field based, splatting-based, etc.), the volumetric rendering model may be trained using data derived from a deformable mesh model.

The machine learning model processes the input to generate an output. An artificial neural network includes an input layer that consists of values in a data point (e.g., intensity values and/or height values of pixels in a height map). The next layer is called a hidden layer, and nodes at the hidden layer each receive one or more of the input values. Each node contains parameters (e.g., weights) to apply to the input values. Each node therefore essentially inputs the input values into a multivariate function (e.g., a non-linear mathematical transformation) to produce an output value. A next layer may be another hidden layer or an output layer. In either case, the nodes at the next layer receive the output values from the nodes at the previous layer, and each node applies weights to those values and then generates its own output value. This may be performed at each layer. A final layer is the output layer, where there is one node for each class, prediction and/or output that the machine learning model can produce. For example, for an artificial neural network being trained to predict a 3D skull structure from a 3D skin mesh representative of the outer surface of a patient's head, or in some embodiments, the 3D skin mesh in combination with a 3D model of the patient's dentition (also referred to herein as a “3D teeth model”).

In at least one embodiment, processing logic may determine an error (i.e., a positioning error) based on the differences between the output dental feature and the known correct dental feature. Processing logic can adjust weights of one or more nodes in the machine learning model based on the error. An error term or delta may be determined for each node in the artificial neural network. Based on this error, the artificial neural network adjusts one or more of its parameters for one or more of its nodes (the weights for one or more inputs of a node). Parameters may be updated in a back propagation manner, such that nodes at a highest layer are updated first, followed by nodes at a next layer, and so on. An artificial neural network contains multiple layers of “neurons,” where each layer receives as input values from neurons at a previous layer. The parameters for each neuron include weights associated with the values that are received from each of the neurons at a previous layer. Accordingly, adjusting the parameters may include adjusting the weights assigned to each of the inputs for one or more neurons at one or more layers in the artificial neural network.

Once the model parameters have been optimized, model validation may be performed to determine whether the model has improved and to determine a current accuracy of the deep learning model. After one or more rounds of training, processing logic may determine whether a stopping criterion has been met. A stopping criterion may be a target level of accuracy, a target number of processed images from the training dataset, a target amount of change to parameters over one or more previous data points, a combination thereof and/or other criteria. In at least one embodiment, the stopping criteria is met when at least a minimum number of data points have been processed and at least a threshold accuracy is achieved. The threshold accuracy may be, for example, 70%, 80%, or 90% accuracy. In at least one embodiment, the stopping criteria is met if accuracy of the machine learning model has stopped improving. If the stopping criterion has not been met, further training is performed. If the stopping criterion has been met, training may be complete. Once the machine learning model is trained, a reserved portion of the training dataset may be used to test the model.

Once one or more trained ML models are generated, they may be stored in the data store 125, and may be added to the intraoral scan application 115 and/or utilized by the dental modeling logic 116. Intraoral scan application 115 and/or dental modeling logic 116 may then use the one or more trained ML models as well as additional processing logic for modeling and visualizing a patient's facial structure. The trained machine learning models may be trained to perform one or more tasks in at least one embodiment. In at least one embodiment, the trained machine learning models are trained to perform one or more of the tasks set forth in U.S. Patent Application Publication No. 2021/0059796 A1, entitled “Automated Detection, Generation, And/or Correction of Dental Features in Digital Models,” which is hereby incorporated by reference herein in its entirety. In at least one embodiment, the trained machine learning models are trained to perform one or more of the tasks set forth in U.S. Patent Application Publication No. 2021/0321872 A1, entitled “Smart Scanning for Intraoral Scans,” which is hereby incorporated by reference herein in its entirety. In at least one embodiment, the trained machine learning models are trained to perform one or more of the tasks set forth in U.S. Patent Application Publication No. 2022/0202295 A1, entitled “Dental Diagnostics Hub,” which is hereby incorporated by reference herein in its entirety.

In at least one embodiment, model application workflow includes a first trained model and a second trained model. First and second trained models may each be trained to perform segmentation of an input and identify a dental feature therefrom, but may be trained to operate on different types of data. In at least one embodiment, a single trained machine learning model is used for analyzing multiple types of data.

According to one embodiment, an intraoral scanner generates a sequence of intraoral scans and 2D images. A 3D surface generator may perform registration between intraoral scans to stitch the intraoral scans together and generate a 3D surface/model from the intraoral scans. Additionally, 2D intraoral images (e.g., color 2D images and/or NIRI 2D images) may be generated. Additionally, as intraoral scans and 2D images are generated, motion data may be generated by an IMU of the intraoral scanner and/or based on analysis of the intraoral scans and/or 2D intraoral images.

Data from the 3D model/surface may be input into first trained model, which outputs a first dental feature. The first dental feature may be output as a probability map or mask in at least one embodiment, where each point has an assigned probability of being part of a dental feature and/or an assigned probability of not being part of a dental feature. The dental feature(s) may each be output as a probability map or mask in at least one embodiment, where each pixel of the input 2D image has an assigned probability of being a dental feature and/or an assigned probability of not being a dental feature.

In at least one embodiment, the machine learning model is additionally trained to identify teeth, gums and/or excess material. In at least one embodiment, the machine learning model is further trained to determine one or more specific tooth numbers and/or to identify a specific indication (or indications) for an input image. Accordingly, a single machine learning model may be trained to identify dental features and also to identify teeth generally, identify different specific tooth numbers, identify gums and/or identify other features (e.g., margin lines, etc.). In an alternative embodiment, a separate machine learning model is trained for each specific tooth number and for each specific indication. Accordingly, the tooth number and/or indication (e.g., a particular dental prosthetic to be used) may be indicated (e.g., may be input by a user), and an appropriate machine learning model may be selected based on the specific tooth number and/or the specific indication.

In an embodiment, the machine learning model may be trained to output an identification of a dental feature as well as separate information indicating one or more of the above (e.g., path of insertion, model orientation, teeth identification, gum identification, excess material identification, etc.). In at least one embodiment, the machine learning model (or a different machine learning model) is trained to perform one or more of: identify teeth represented in height maps, identify gums represented in height maps, identify excess material (e.g., material that is not gums or teeth) in height maps, and/or identify dental features in height maps.

FIG. 2 illustrates an exemplary modeling pipeline 200 for generating 2D images and 3D models of a patient's head and facial features, in accordance with at least one embodiment. The modeling pipeline may be integrated into a visualization and dental treatment planning workflow to provide photorealistic or near-photorealistic estimations of post-treatment outcomes on the virtual patient, which can be used for the purposes of informing a patient's decisions regarding treatment. In at least one embodiment, the modeling pipeline comprises four workflows: a skull estimation workflow 210, a tissue optimization workflow 220, a photorealistic rendering workflow 230, and an image enhancement workflow 240. In at least one embodiment, the modeling pipeline receives patient input data 202, for example, as input to the skull estimation workflow 210. In at least one embodiment, the modeling pipeline further includes a physically-based dental/medical/aesthetic treatment simulation workflow. In at least one embodiment, some or all of the patient input data 202 may be received and used as input to any of the other workflows in the modeling pipeline 200. In at least one embodiment, patient input data 202 can include, but is not limited to, 2D photographs of a patient's head/face, a video of the patient's head/face, intraoral scan data, 3D face scan data, CBTC or partial CBCT scan data, X-ray scan data (e.g., panoramic X-ray, cephalometric X-ray scan data, etc.), magnetic resonance imaging scan data, 3D model data (including a 3D mesh or 3D volumetric data), 2D texture data (e.g., UV-mapped texture data), data previously generated by the modeling pipeline 200 or one or more workflows thereof, or combinations thereof. In at least one embodiment, the image/model data 204 that is outputted from the modeling pipeline 200 may include, but is not limited to one or more 3D teeth models, one or more 3D skull models, one or more 3D skin models representative of an outer surface of the patient's head, one or more before-and-after treatment volumetric meshes (e.g., a finite element mesh) representative of hard- and/or soft-tissue changes due to the medical treatment, one or more deformable differentiable volumetric rendering models (e.g., RF-based, Splatting-based, etc.), one or more enhanced 2D images, one or more enhanced 3D models, or a combination thereof.

The workflows of the modeling pipeline 200 are illustrated in a cascading format. However, it is to be understood that other arrangements of the workflows are contemplated. For example, the workflows may be presented in a different order, may be performed concurrently, or may be omitted entirely. For example, the modeling pipeline 200 may omit the skull estimation workflow 210 for a particular patient if 3D skull model data is already available for that patient (e.g., a 3D skull model is derivable or has been derived from CBTC scan data for that patient).

The exemplary skull estimation workflow 210 is now described. The significance of physically representing facial features has been increasingly recognized within the realms of facial animation and simulation. Particularly important is the interplay between soft tissue and the skeletal structure, which is important for the purpose of enhancing visual fidelity. Therefore, one objective of the present embodiments is to predict the skull shapes from 3D facial scans with a high level of accuracy. Distinguishing this from previous approaches, an additional intraoral scan, registered to the face, can serve as an optional input. In a first approach, machine-learning is utilized to enable the learning of a parametric 3D model of elements such as the mandible bone, cranium bone, skin surface, tooth positions, or a combination thereof. This model is informed by dimensionality reduction techniques (PCA, AE, VAE, etc.) applied to data comprising registered skin-and skull-mesh pairs obtained from CBCT scans and registered intraoral scans. This means, for example, that an encoder and decoder network are trained for each modality and one can project the registered input modality into the lower dimensional latent space (and reproject back). For each new input modality, an optimal latent vector can be determined (e.g., in a least square sense), which can then be referred to as the fitted latent code/vector. Machine learning/deep learning networks, such as a multilayer perceptron (MLP) or more complex network architectures, can be trained to directly learn the mapping from fitted latent vectors of the input modalities to the bone structure latent vector. In a second approach, a machine-learning model can learn a lower dimensional joint model of all modalities present in the dataset. An optimization approach can then be used to find the best latent fit for any new input scan (e.g. skin) according to a specified metric (e.g. chamfer distance from input skin to reprojected skin). The optimized latent code (e.g., fitted vector) can then be used with the decoder network to generate the joint head mesh, which provides the desired bone geometries. In a third approach, a machine-learning model can learn to adjust/correct the latent vector when dealing with joint models of skin, bone, and teeth that have been fitted to the input modalities. The training of these networks uses data that includes registered pairs of skin and skull meshes from CBCT scans, or in some cases, combinations of skin, bone, and teeth meshes. This data then informs the prediction of the skull shape based on a given skin surface. By incorporating tooth positions as additional prior information extracted from intraoral scans, the embodiments advantageously improve the accuracy compared to the traditional approaches, especially within the oral region of the predicted skull. As a result, the embodiments allow for versatile applications, spanning from a simplified generation of physical faces for visual effects to radiation-free medical visualizations and simulations. The methodologies of the skull estimation workflow 210 may integrate seamlessly into automated pipelines for medical and cosmetic visualization and simulation. The methodologies further provide a radiation-free approach to capturing, modeling, and predicting a patient's facial bone structure, and have contemplated applications in facial reconstruction applications and in forensic investigations (such as identifying human remains).

In an exemplary method, 3D mesh data of a patient's face (also referred to as a “3D skin model”) is obtained or derived from a facial scan and using a machine learning algorithm to predict the shape and size of the patient's cranium and mandible based on shape of the face. For example, the facial scan may be performed as described in U.S. Non-Provisional patent application Ser. No. 18/239,712, filed on Aug. 29, 2023, the disclosure of which is hereby incorporated by reference herein in its entirety. The 3D skin model may comprise a set of vertices and polygons that define the shape and texture of the patient's face. In at least one embodiment, an aligned intraoral scan can be provided as an additional input to obtain a more accurate bone shape estimate. In at least one embodiment, the method can be used to generate a less accurate version of the skull structure directly from one or multiple RGB images of the patient (e.g., a single lateral or frontal image or a combination of multiple images from different angles).

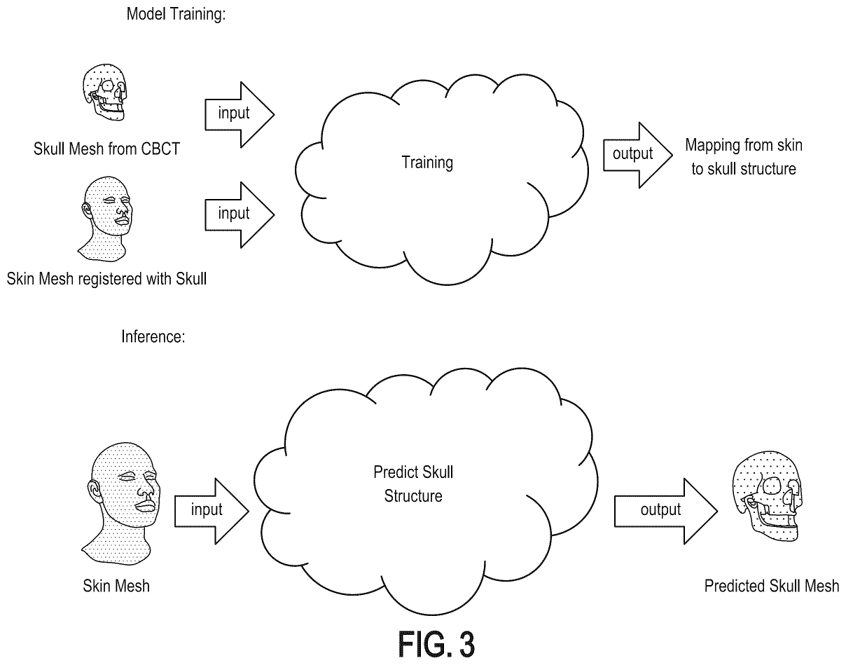

FIG. 3 illustrates model training and inference for predicting skull structure, in accordance with at least one embodiment. In at least one embodiment, a dataset of CBCT scans is collected that includes information describing both the bone structure and the soft tissue of the skin. Bone structure and skin data can be extracted using a manual or semi-automatic segmentation and registration algorithm. When both bone structure and skin data are extracted from the same CBCT datasets, 3D skull model and 3D skin mesh are perfectly aligned. In at least one embodiment an additional intraoral scan of the patient can be aligned with the teeth in the CBCT scan. In other embodiments for which the 3D skull model and the 3D skin model are derived from different datasets (e.g., the 3D skull model is derived from CBCT scan data and the 3D skin model is derived from a facial scan based on image capture), a registration step may performed to align the 3D skull model to the 3D skin model.

In at least one embodiment, registration of 3D skull models and 3D skin meshes to produce skin-skull pairs for model training can be performed manually, can be partially automated, or can be fully automated. An exemplary method to manually prepare a skin-skull pair may be performed as follows: (1) set two density thresholds for CBCT scan data, one for soft-tissue (corresponding to the surface of the face) and one for hard-tissue (corresponding to the bone surface); (2) using the two density thresholds, extract the resulting iso-surface as a 3D mesh (e.g., using a marching cubes algorithm); and (3) register the 3D mesh to a known topology (e.g., using 3D mesh registration software, such as Wrap3D). An exemplary method to partially or fully automate preparation of a skin-skull pair may be performed as follows: (1) utilize a machine learning model to predict two density thresholds for CBCT scan data; (2) perform segmentation of the CBCT scan data based on the two density thresholds; and (3) use existing 3D facial landmark detection to automate registration. Another exemplary method to partially or fully automate preparation of a skin-skull pair with teeth may be performed by fitting an initial version of a parametric skin-skull model to the output of a CBCT segmentation algorithm that is then fused with the intraoral scan (crown geometry from intraoral scan, roots and bone geometry from CBCT) then non-rigidly deforming the model using a deformation technique (such as ARAP or Laplacian surface editing) such that the registered skin-skull shape/position matches the CBCT segmentation as closely as possible. For example, both the CBCT segmentation algorithm and the fusion of the output with intraoral scan data can be performed as described in International Patent Application Publication No. WO 2022/109500 A1, entitled “Automatic Segmentation of Dental CBCT Scans,” which is hereby incorporated by reference herein in its entirety. Another exemplary method to partially or fully automate preparation of a skin-skull pair may be performed by fitting an initial version of a parametric skin-skull model to the volumetric CBCT scan data directly, then non-rigidly deforming the model using a deformation technique (such as as-rigid-as-possible (ARAP) or Laplacian surface editing) such that the registered skin-skull shape/position matches the CBCT bone iso-surface as closely as possible.

In at least one embodiment, a machine learning model is trained using sets of face-skull pairs (i.e., aligned and registered 3D skin models with corresponding 3D skull models) so that the model learns the relationship/mapping between the 3D skin model of the patient's face and the CBCT-derived bone structure. In at least one embodiment, the machine learning model is trained using supervised learning, where the correct mappings between the bone structure data and skin data are provided as ground truth. In at least one embodiment, the machine learning model may be trained on different types of data sets, such as magnetic resonance imaging (MRI) data to estimate soft-tissue structures (e.g., muscle, fat, ligaments, airways, etc.).

During inference, as shown in FIG. 3, 3D facial scan (or a derived 3D skin mesh) can be provided as input to the trained machine learning model to predict/estimate the size, shape, and position of the patient's skull. In at least one embodiment, patient-specific 3D tooth meshes (registered to the face) may further be provided as inputs to more accurately estimate cranium/mandible structure. For example, the skull estimation workflow 210 can utilize intraoral scan data to inform the shape of the patient's dental arch, and correspondingly the mandible. In other embodiments, an aligned intraoral scan can be used post-prediction to deform the 3D skull model such that both dental arches from the intraoral scan align optimally with the predicted structure of the 3D skull model. In at least one embodiment, such post-prediction optimization can be performed as deformations in mesh space, or deformations in a lower dimensional latent space of the machine learning model prior to outputting the predicted 3D skull model. A 3D skull model generated based on aligned intraoral scan data can be used to initialize a patient-specific virtual articulator to improve dental treatment planning to simulate articulation of the mandible in relation to the maxilla, simulate static/dynamic occlusion, and enable a dentist or orthodontist to plan and simulate dental treatment procedures. Moreover, 3D animations and visualizations of the treatment plan can be used to improve patient communication, which can improve patient satisfaction and adherence to the treatment plan.

In at least one embodiment, one or more of the 3D skin models may be derived from a facial scan while the patient's mouth is open (“open mouth scan”) or closed (“closed mouth scan”). In at least one embodiment, a 3D skull model may be estimated based on 3D skin model derived from an open mouth scan together with an aligned intraoral scan (e.g., using a machine learning model). In at least one embodiment, a 3D skull model may be estimated based on a 3D skin model alone, and then optimized using (potentially non-aligned) intraoral scan data such that the shape of the maxilla/mandible in the alveolar bone region matches the shape of the intraoral scan data as closely as possible. In at least one embodiment, mandible position and/or lower arch intraoral scan position can be estimated while either assuming a fixed bite (e.g., given by the intraoral scan) assuming closed bite or any other fixed lower arch position relative to upper arch, or estimating bite (i.e., articulation), which can be performed by training on a dataset of different mandible positions and/or including an articulator model.

In various embodiments, the machine learning model used in the skull estimation workflow 210 may be configured to receive other types and combinations of inputs to estimate the 3D skull model at inference. These sets of inputs may include, but are not limited to: (1) facial scan data (or a 3D skin model derived therefrom), 3D intraoral scan data (or 3D tooth models derived therefrom), and cephalometric X-ray scan data; (2) facial scan data (or a 3D skin model derived therefrom), 3D intraoral scan data (or 3D tooth models derived therefrom), and partial CBCT scan data; (3) facial scan data (or a 3D skin model derived therefrom), 3D intraoral scan data (or 3D tooth models derived therefrom), and panoramic X-ray scan data; and (4) facial scan data (or a 3D skin model derived therefrom), 3D intraoral scan data (or 3D tooth models derived therefrom), and patient-specific articulation capture data. In at least one embodiment, the machine learning model may utilize a parametric head model based on volumetric computed tomography (CT) density data (e.g., as a semi-supervised model), based on volumetric MRI density data, based on, for example, a NeRF model, or based on a combination thereof.

In at least one embodiment, a semi-supervised training loss may be used to further improve the model training. Such training loss variants may include, but are not limited to: volumetric reprojection error on unlabeled data; chamfer (or other types of mesh-to-mesh distance) loss between a computed iso-surface and a estimated 3D skull in mesh space, penalization of volumetric design computed outside of the 3D skin mesh; rewarding non-zero density inside of the 3D skin mesh, and rewarding high volumetric density inside and close to the 3D skull model.

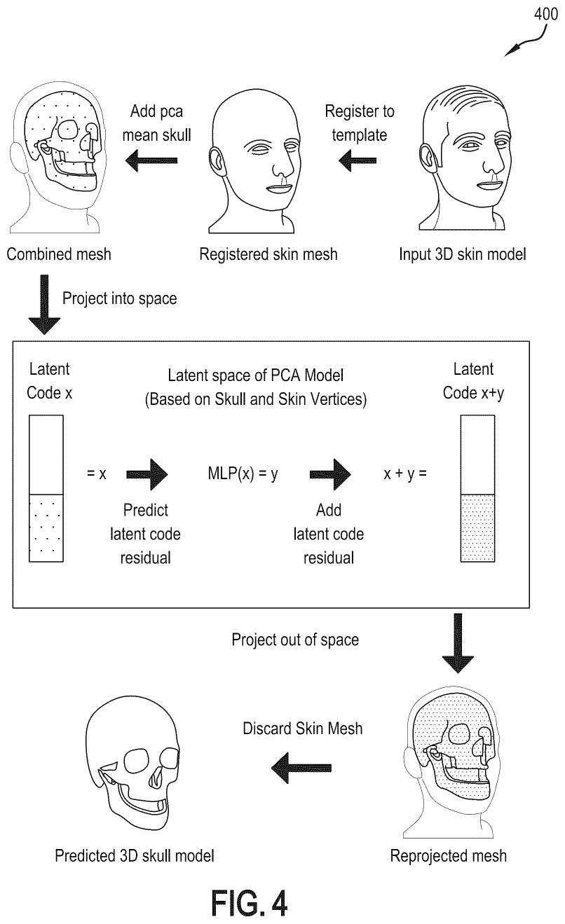

FIG. 4 illustrates an exemplary pipeline 400 for predicting a 3D skull model of a patient, in accordance with at least one embodiment. The pipeline 400 illustrates the inference process, and includes three main stages: preparing the input data, applying the machine learning model, and processing the model output.

In at least one embodiment, the preparation stages comprises receiving a 3D skin model representing the outer surface of the head as input. In at least one embodiment, the 3D skin model is first registered to a template representative of a generic head, which may be a parametric head mesh/model (e.g., a FLAME mesh as described in Li et al., “Learning a model of facial shape and expression from 4D scans,” ACM Trans. Graph. 36.6 (2017): 194-1).

A combined mesh can generated by combining the registered 3D skin model with a mean skull generated via a principal component analysis (PCA). An exemplary process for generating the combined mesh is now described: (1) register the 3D skin model (having Nₛₖᵢₙ vertices) and the mean skull (having Nₛₖᵤₗₗ vertices) with a common respective topology; (2) construct a PCA space of the combined mesh where the respective mesh vertex matrices are flattened; each data point comprises a one-dimensional vector of length M=(Nₛₖᵢₙ*3)+(Nₛₖᵤₗₗ*3), resulting in a data matrix D of size L×M (where L is the number of data sets used to register the template topology); (3) construct a PCA latent space that is spanned by principal components of D (e.g., the first k principal components). A projection of a data point d∈R^{1×M} can be described by P(d)∈R^{1×k} for a PCA latent space using k principal components.

If d∈R^{1×M} is a data point from D, then d can be separated into two vectors: dₛₖᵢₙ∈R^{1×(Nskin*3)} and dₛₖᵤₗₗ∈R^{1×(Nskull*3)}, representing the skin part and the skull part of data point d. Next, mₛₖᵤₗₗ∈R^{(Nskull)*3} is the skull part of the mean vector of D. This mean skull vector can then be used to construct the data point vector, dₘ∈R^{1×M}, by replacing the original skull part of d, which is dₛₖᵤₗₗ, with mₛₖᵤₗₗ. This replacement procedure can be repeated for all of d∈D to construct a new data set matrix Dₘ∈R^{L×M}, resulting in two data sets, D and Dₘ, representing the ground truth data set and the same data set that consists of PCA combined mesh vectors instead of ground truth skull vectors.

In at least one embodiment, at the inference stage of the pipeline 400, the result of the registration of the 3D skin mesh is concatenated vector d′ₛₖᵢₙ. The PCA mean skull vector mₛₖᵤₗₗ is then concatenated to d′ₛₖᵢₙ to get the vector d′ₘ∈R^{1×M}. In at least one embodiment, an input vector x=P(d′m) is generated and used as input to the trained machine learning model (e.g., MLP layer) to generate a latent space vector y=Pᵣₑₛ(d′, d′ₘ)=MLP(P(d′ₘ)). In at least one embodiment, the predicted residual latent code y is then added to the input latent code x to obtain a prediction for P(d′,d′ₘ).

At the output processing stage of the pipeline 400, x+y is projected out of the latent space into data space to obtained a flattened mesh vector d′_{pred}. The 3D skin model part of the combined mesh vector is then discarded to obtain the predicted 3D skull model vector d′_{pred skull}, which is then rearranged into a vertex matrix format to serve as the skull predicted 3D skull model for downstream use.

In at least one embodiment, the mean skull is trained into the model itself such that an input vector representative of only the 3D skin model can be used. In at least one embodiment, a latent space (PCA, AE, VAE, etc.) may be generated for each of the 3D skull mesh, the 3D skin mesh, and/or a 3D mesh derived from intraoral scan data (if available as input). A machine learning-based approach can then be used to learn the mapping from one set of latent spaces to another, for example, the mapping from face and intraoral latent spaces to skull latent space. In at least one embodiment, the machine learning model is trained on data for which 3D meshes representative of teeth are registered to 3D skin meshes prior to generating a latent space.

In at least one embodiment, if 3D mesh data representative of the patient's teeth is available in combination with the 3D skin model, the pipeline 400 can be adapted to leverage the teeth information for more prediction accuracy in the mouth area, making the resulting predictions of the 3D skull model more accurate and suitable for orthodontics visualizations and applications. In such embodiments, the pipeline 400 further receives as input a 3D mesh representative of the teeth, which may be derived from the patient's intraoral scan data.

In general, intraoral scan data or 3D mesh data derived therefrom does not share a common topology with the other mesh data. To account for this, the pipeline 400 may incorporate information about the gum boundary to rather than the entire teeth mesh. The gum boundary can provide valuable information about the mouth area geometry of the 3D skull model. To extract this gum boundary information, the pipeline 400 can leverage the fact that intraoral scan-derived meshes have flat geometry where the gum boundary is. Each teeth mesh can be processed by first identifying the edges on these flat geometry areas, calculating the per-tooth center of these edges, and then fitting a spline curve through these per-tooth center points. The top and bottom spline curves therefore can be thought of as an approximation of the teeth-gum boundary. For the model input, the pipeline 400 can sample each of the two spline curves with, for example, 3000 sample points, flatten the corresponding point matrix, and concatenate the data point d from the above-described model with the teeth-point vector of size 6000*3. In at least one embodiment, the remaining aspects of the pipeline 400 can remain the same.

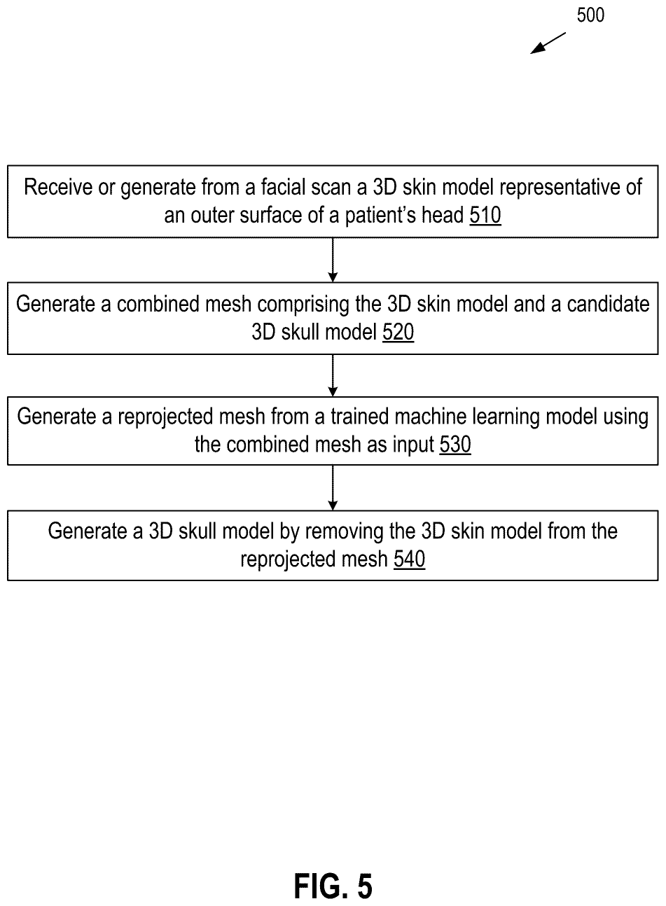

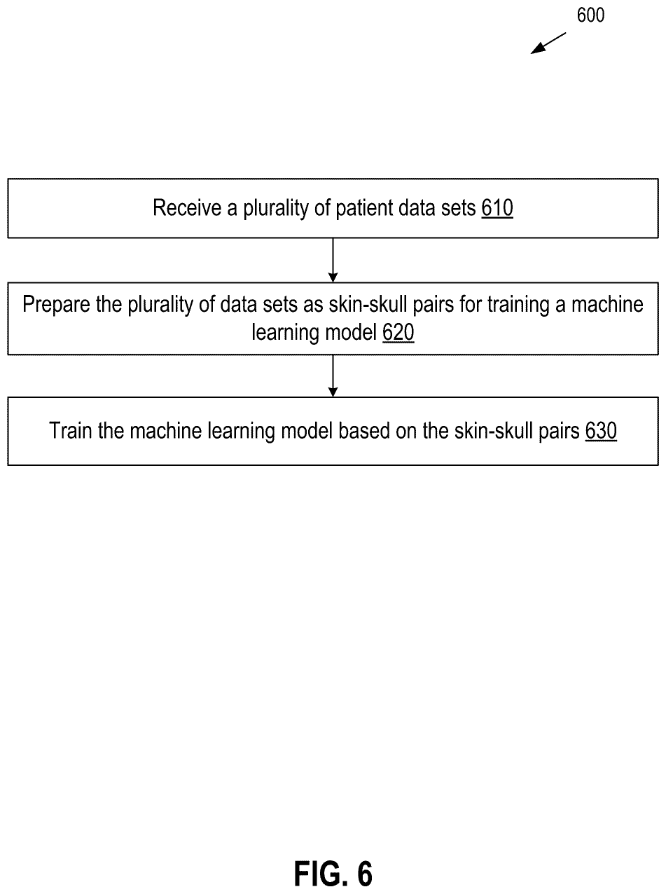

FIGS. 5 and 6 are flow diagrams illustrating exemplary methods 500 and 600, respectively, of estimating a 3D skull model representative of a patient's facial bone structure, in accordance with at least one embodiment. The methods 500 and 600 may be implemented as part of the skull estimation workflow 210, and may be performed by a processing logic that may comprise hardware (e.g., circuitry, dedicated logic, programmable logic, microcode, etc.), software (e.g., instructions run on a processing device to perform hardware simulation), or a combination thereof. In at least one embodiment, at least some operations of the methods 500 and 600 are performed by a computing device executing a dental modeling application, such as the simulation logic 118 of FIG. 1.

Referring now to the method 500 of FIG. 5, at block 510, the computing device receives, or generates from a facial scan, a 3D skin model representative of an outer surface of the patient's head. In at least one embodiment, the 3D skill model is generated or derived from a facial scan of a patient. For example, the facial scan may comprise a plurality of 2D images of the patient's face captured at different orientations with respect to the patient's face. In at least one embodiment, the computing device receives a pre-existing 3D skin model without generating or deriving it from facial scan data. In at least one embodiment, other types of input data may be received including, but not limited to: panoramic X-ray scan data, cephalometric X-ray scan data, magnetic resonance imaging scan data, partial cone beam computed tomography scan data, articulation capture data, or a combination thereof.

At block 520, the computing device generates a combined mesh comprising the 3D skin model and a candidate 3D skull model (e.g., a combined mesh as described above with respect to the pipeline 400). For example, in at least one embodiment, generating the combined mesh comprises combining the 3D skin model with the candidate 3D skull model. The registration process may utilize facial landmarks to estimate position and orientation of the candidate 3D skull model with respect to the 3D skin model. In at least one embodiment, the combined mesh is prepared for inputting into a trained machine learning model, for example, by generating an input vector comprising a latent space representation of the combined mesh.

At block 530, the computing device generates a reprojected mesh from a trained machine learning model using the combined mesh as input. In at least one embodiment, generating the reprojected mesh comprises projecting the latent space representation of the combined mesh into a data space representation.

At block 540, the computing device generates the 3D skull model by removing the 3D skin model from the reprojected mesh.

In at least one embodiment where the computing device receives aligned intraoral scan data representative of the patient's upper and lower dental arches, the processing device may generate reprojected mesh based at least in part on the aligned intraoral scan data. For example, the processing device may implement one or more transformation or deformation operations (e.g., non-rigid deformations) to the 3D skull model to conform its shape and alignment with the upper and lower dental arches of the aligned intraoral scan data. In at least one embodiment, the processing device non-rigidly deforms the 3D skull model to reduce intersections with the 3D skin model.

In at least one embodiment, the 3D skull model is integrated with one or more data sets or processes for use in visualization of a dental treatment plan for the patient (e.g., workflows within the modeling pipeline 200 or downstream processes). For example, the estimated 3D skull model may be used as input to the tissue optimization workflow 220. In such embodiments, the tissue estimation workflow may be used to generate a volumetric mesh representative of soft tissue of a patient's head based on the 3D skin model and the estimated 3D skull model, and the resulting volumetric mesh may be deformable to simulate and predict changes to the virtual patient's face responsive to a dental treatment plan. In at least one embodiment, the volumetric mesh can be used with physically-based simulation techniques to simulate deformations and predict changes to the virtual patient's face (soft-tissue) responsive to the dental treatment plan.

In at least one embodiment, the computing device generates a volumetric mesh representative of soft tissue of a virtual patient's head based on the 3D skin model and the 3D skull model. In at least one embodiment, the volumetric mesh can be used with physically-based simulation techniques to simulate deformations and predict changes to soft tissue of the virtual patient's face responsive to a dental treatment plan. In at least one embodiment, the computing device further generates an additional rigid mesh representative of teeth, and simulates teeth-to-teeth contact to predict changes to the virtual patient's bite and resulting soft and hard tissue changes responsive to the dental treatment plan.

In at least one embodiment, the computing device further generates additional anatomical constraints in the temporomandibular area of the virtual patient's jaw (e.g., the hinge axis, or more complex modeling of contact between condyle and fossa) to simulate changes to the virtual patient's bite (teeth-to-teeth contact) and the resulting soft and hard tissue changes responsive to the dental treatment plan.

In at least one embodiment, the computing device simulates the dynamic occlusion jaw motion of the virtual patient based on teeth-to-teeth modeling For example, the lower arches can be modeled to follow prescribed functional trajectories. Such simulation can help assess how the teeth will interact during various movements, providing insight into functional occlusion as part of the dental treatment plan.

In at least one embodiment, the computing device further generates additional anatomical constraints in the temporomandibular area of the virtual patient's jaw (e.g., the hinge axis, or more complex modelling of contact between condyle and fossa) to provide a better informed simulated dynamic occlusion jaw motion of the virtual patient.

The following exemplary methods related to the method 500 are now described for which, at inference time a machine learning model-based approach is used to generate a 3D skull model directly from an input 3D skin model. In at least one embodiment of a first method, the computing device receives, or generates from a facial scan, a 3D skin model representative of an outer surface of the patient's head. In at least one embodiment, the computing device projects the input 3D skin model into a learned skin latent space. In at least one embodiment, the computing device applies the learned mapping from skin latent code to skull latent code to compute the corresponding coordinates in the learned skull latent space. In at least one embodiment, the computing device reprojects the skull latent space coordinates back to the 3D skull model.

In at least one embodiment of a second method, the computing device receives, or generates from a facial scan, a 3D skin model representative of an outer surface of the patient's head. In at least one embodiment, the computing device determines skin-bone model latent code by computing a fit according to a specified loss (e.g., chamfer distance from input face to joint model skin). In at least one embodiment, the computing device generates the 3D skull model from optimized joint skin-bone model fit.

In at least one embodiment, the computing device receives additional CBCT scan data and intraoral scan data for input. In at least one embodiment, the CBCT scan data is segmented and fused with the intraoral scan data. A joint head model can then be fitted to a fused CBCT/intraoral scan to complete the partial input CBCT scan resulting in a full head 3D skull reconstruction model. In at least one embodiment, the computing device applies a deformation (e.g., an ARAP deformation or Laplacian surface editing) to deform the 3D skull model in areas sufficiently covered by the input partial CBCT scan.

In at least one embodiment, the 3D skin model is extracted from a 3D facial scan of the patient that is registered to the input intraoral scan.

In at least one embodiment, the method 500 is applied to any dataset of paired 3D facial scan data, intraoral scan data, and/or CBCT scan data to automatically generate a skin-skull-teeth dataset.

FIG. 6 is a flow diagram illustrating an exemplary method 600 of training a machine learning model to predict skull structure of a patient, in accordance with at least one embodiment. At block 610, the computing device provides a plurality of data sets as training data, each data set corresponding to a particular patient and comprising at least a 3D skin model representative of an outer surface of the patient's skin and a 3D skull model representative of the patient's skull. In at least one embodiment, the trained machine learning model is configured to compute a 3D skull model at inference in response to a 3D skin model as input.

At block 620, the computing device prepares the plurality of data sets as skin-skull pairs for training the machine learning model. The preparation may be performed with user input, may be partially automated, or may be fully automated. In at least one embodiment, each data set corresponds to a specific patient and includes a 3D skin model of the patient (which may have been derived from a facial scan of that patient) and a corresponding 3D skull model of the patient. In at least one embodiment, the 3D skull model comprises or is derived from cone beam CBCT scan data. In at least one embodiment, at least one of the plurality of data sets further comprises aligned intraoral scan data for the corresponding patient. In at least one embodiment, for each of the plurality of data sets, the computing device registers the 3D skin model to its corresponding 3D skull model. In other embodiments, the 3D skin model and the 3D skull model may be derived from the same source data, such as CBCT scan data, based on a segmentation process. In such embodiments, registration of the 3D skin model to the 3D skull model can be omitted. In at least one embodiment, for at least one skin-skull-teeth pairs data set, the 3D skull model comprises or is derived from cone beam computed tomography and intraoral scan data.

In at least one embodiment, the computing device generates each of the plurality of data sets as an input vector comprising a latent space representation of the 3D skin model and corresponding 3D skull model.

At block 630, the computing device trains the machine learning model based on the plurality of data sets (skin-skull pairs). In at least one embodiment, the machine learning model comprises a supervised machine learning model to determine mappings between bone structure data and skin data derived from the plurality of data sets. In at least one embodiment, latent code matrices P(D). In at least one embodiment, for learning inside of the latent space, latent code matrices P(D)∈R^{M×Q} and P(Dm)∈R^{L×Q}, may be generated, where L is the number of training datasets and Q is the number of principal components used, for which are used to construct Pᵣₑₛ(D, Dₘ)=P(D)−P(Dₘ). In at least one embodiment, the machine learning model comprises a multi-layer (e.g., 4-layer) MLP that takes as input P(d)∈P(D) and learns to predict Pᵣₑₛ(d, dₘ). In at least one embodiment, the MLP has hidden layers (e.g., of size 410). In at least one embodiment, the MLP utilizes ReLU activation functions. In at least one embodiment, Huber loss is used to compute training loss.

The following exemplary method related to the method 600 is now described for which. In at least one embodiment, the method comprises training of a parametric head model (e.g., skin-skull model or skin-skull-teeth model) that can be used with an optimization-based method to reconstruct a 3D skull model based on a patient's lateral (and/or frontal) cephalometric scan. In at least one embodiment, during optimization, the parametric head model is fitted to an input cephalometric scan. In at least one embodiment, joint head model latent code is optimized such that a rendered lateral/frontal projection is fitted to the input cephalometric scan. In at least one embodiment, rendered lateral/frontal projection (e.g., based on a differentiable volumetric rendering) is further fitted to an input intraoral scan.

The exemplary tissue optimization workflow 220 is now described, which relates to optimizing a volumetric mesh of a virtual patient's head for dental treatment simulations. In at least one embodiment, the tissue optimization workflow 220 includes a method of generating a volumetric mesh representative (e.g., a finite element mesh) of soft tissue of a patient's head. In at least one embodiment, the tissue estimation workflow may receive an estimated 3D skull model as input from the skull estimation workflow 210. Alternatively, the 3D skull model may be obtained from CBCT scan data, from cephalometric scan data, or from other patient data. In at least one embodiment, the tissue optimization workflow 220 generates a patient-specific finite-element simulation mesh that is optimized for dental treatment simulations. For example, it can be used in connection with other upstream or downstream processes to model various aspects patients head, including patient-specific teeth (crowns only or crowns with roots), bones (cranium, mandible, hyoid bone, spine, etc.), bite (habitual occlusion, centric occlusion, full articulation model), soft tissue (muscles, fat, ligaments, gingiva, tongue, soft palate, etc.), skin, and/or texture (color). For any patient, the simulation mesh can be used to model orthodontic treatment, restorative treatment, prosthodontic treatment, and/or orthognathic surgery treatment. Soft and hard tissue deformations and changes to the virtual patient's bite resulting from treatment can then be simulated (forward simulation) and visualized (for treatment planning, outcome prediction purposes, and communication with the patient). Appropriate material models, such as the hyper-elastic neo-Hookean material model where Poisson's ratio and Young's modulus are chosen to reflect typical facial soft-tissue material properties found in humans, can be chosen to model the elastic soft-tissue of the virtual patient. The patient-specific model (virtual patient) can also be used for applications such as treatment/surgery planning or material parameter estimation that require differentiable (i.e., backward) simulation. Other applications include, but are not limited to, dental occlusion modeling and prediction, facial aesthetics, facial growth and development, temporomandibular joint health treatment, patient communication (e.g., understanding patient preferences and expectations), restorative dentistry, ortho-restorative treatment, prosthodontic treatment, maxillofacial surgery, and virtual treatment simulation.

Current approaches for simulation-driven prediction rely on manually-created and/or off-the-shelf meshes that fail to account for specificities of dental treatment applications. Data-driven simulations could potentially be realized from data sets that contain for each identity the geometry changes due to biological/biomechanical processes/changes such as articulation, growth/ageing, expressions, weight gain/loss. However, physical data acquisitions can be difficult, time consuming, and expensive due to requiring large number of different identities (e.g., patients, study participants), difficulties in data capture due to unintended soft-tissue changes resulting from changes in neck pose, bite/articulation, expression, time of capture (aging, fat gain/loss, muscle gain/loss), and/or breathing. In addition, while CBCT scan data can provide detailed physical information, the acquisition exposes patients to radiation, is expensive, and requires trained experts and specialized equipment.

The embodiments described with respect to the tissue optimization workflow 220 rely on physically-based simulation, which can address the aforementioned limitations, by creating or extending existing 3D geometry datasets. For example, the tissue optimization workflow 220 can be used on datasets of specific patients to create datasets of synthetic by deforming a patient-specific geometry. Such simulations include, but are not limited to: (1) simulating soft/hard tissue changes due to orthodontic/restorative/prosthodontic/orthognathic surgery treatments; (2) simulating soft-tissue changes due to articulation (e.g., by rigidly transforming the mandible and lower teeth, according to a virtual articulator, to articulate the head model); (3) simulating soft-tissue changes due to an increase/decrease in body-fat percentage by growing/shrinking the finite element volumes in the neutral, stress-free reference state; (4) simulating soft and hard tissue changes due to ageing using existing parametric models that describe cranium/mandible growth, deform skull and mandible geometries to reflect a specified change in age; (5) simulating soft tissue changes due to expressions resulting from muscle activation simulation; and/or (6) creating new identities by augmenting existing identities, for example, using blendshapes (or a parametric shape model such as a PCA bone model, or any other deformation technique) to change the patient's bone shape and/or change tooth positions.

In addition, datasets generated/extended by the tissue optimization workflow 220 can be used with learning methods (e.g. 3D geometric deep learning) to learn, for example: (1) the mapping from orthodontic treatments, restorative treatments, prosthodontic treatments, and/or orthognathic surgery to resulting hard-and soft-tissue deformations; (2) the mapping from articulation (e.g., rigid transformation of the mandible bone) to soft tissue deformation; (3) the mapping from expression changes to soft tissue deformation; (4) the mapping from face surface to bone surfaces, while assuming closed bite (e.g., estimated bone shape from face, assuming habitual occlusion); (5) the mapping from aligned facial and teeth surfaces to bone surfaces (e.g., estimate bone shape from face plus teeth); and/or (6) the mapping from face surface to bone surfaces and mandible position (e.g., estimate bone shape plus articulation).

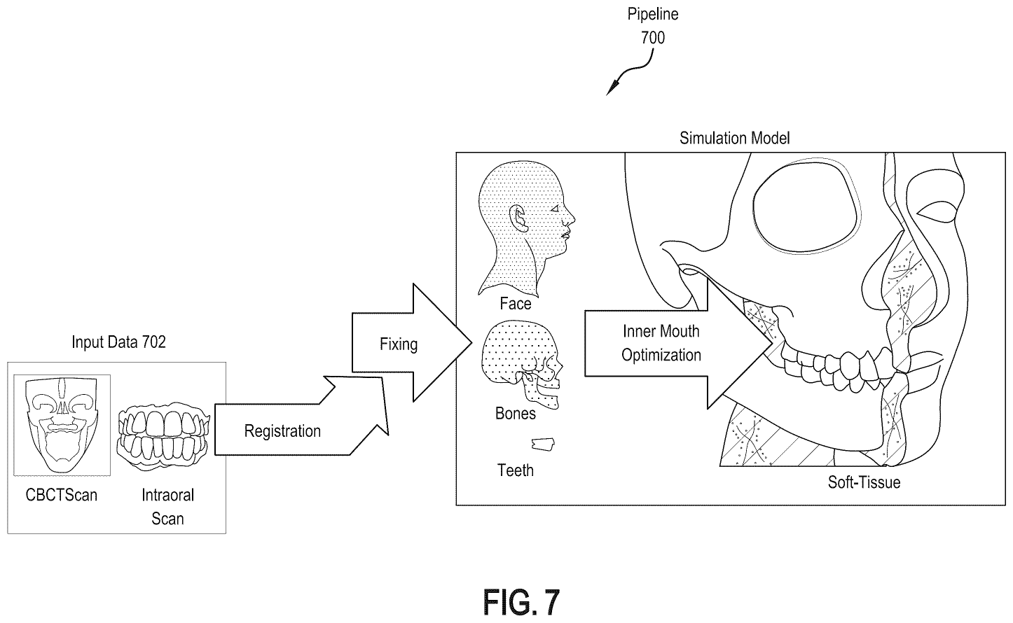

The tissue optimization workflow 220 address these limitations by fully-automating the mesh generation process to produce a virtual patient with a patient-specific volumetric mesh that is deformable to simulate variations in the patient's bone structure. FIG. 7 illustrates an exemplary pipeline 700 for generating a patient-specific volumetric mesh representative of soft tissue of a patient's head, in accordance with at least one embodiment. The pipeline 700 receives input data 702, which may comprise: 3D intraoral scan data, 3D facial scan data (e.g., obtained as described in U.S. Non-Provisional patent application Ser. No. 18/239,712) CBCT scan data, cephalometric scan data, or a combination thereof. In at least one embodiment, the input data 702 comprises a 3D skull model generated, for example, by the skull estimation workflow 210. In such embodiments, the input data 702 may comprise the 3D skull model and 3D facial scan data at a minimum. In embodiments for which CBCT scan data is included in the input data 702, segmentation may be performed to compute a separate 3D skull model and 3D skin model representative of the outer surface of the patient's skin. The output of the pipeline 700 may include a volumetric mesh (e.g., tetrahedral, prismatic, hexahedra, or any other combination of finite elements) representing soft tissue of the virtual patient's head. The volumetric mesh may be compatible with any physically-based simulation (FEM) for any orthodontic treatment, restorative treatment, prosthodontic treatment, and/or orthognathic surgery application. In at least one embodiment, the volumetric mesh may further comprise additional geometries, for example, representing each individual tooth (for simulation of tooth-tissue contact), as well as textural/color data for rendering purposes. Finite element methods used in accordance with the various embodiments described herein may be performed based on, for example, the methodologies described in International Application Publication No. WO2023164007A1, filed Mar. 22, 2022, the disclosure of which is hereby incorporated by reference herein in its entirety.

In at least one embodiment, when intraoral scan data is included with the input data 702, the patient's teeth can be represented using segmented 3D intraoral scan data so that the patient-specific teeth can be individually represented by either a volumetric mesh (tetrahedral, hexahedral, or any other finite element), a surface mesh (triangle, quad or any polygonal), or a point cloud with normals.

In at least one embodiment, a parametric head mesh (e.g., a triangle/quad mesh with a known topology and/or facial landmarks) can be used for registering a 3D skin model derived from the facial scan data. In at least one embodiment, if the input data 702 comprises CBCT scan data, bone surfaces can be segmented and registered to a parametric skull model. To help with the registration process, a machine learning-based 3D landmark detection algorithm can be used to first detect 3D landmarks on CBCT extracted face and bone surfaces. Registration may further take into account patient-specific tooth positions for cranium/mandible estimation.

In at least one embodiment, a template soft-tissue surface mesh (e.g., the surface that encompasses the union of facial soft-tissue structures, including skin, muscle, fat, and ligaments that are integral to function and aesthetics) can be fitted to the patient-specific registered 3D skin model and 3D skull model. The template mesh can be designed in the form of a triangle/quad/polygonal mesh, and may optionally model the trachea, throat, esophagus, nasal cavity, etc.

In at least one embodiment, potential mesh-mesh intersections in the registered meshes (e.g. cranium-face, mandible-cranium, etc.) may be resolved prior to generating the volumetric mesh. In at least one embodiment, potential self-intersections in the registered meshes (e.g. lip-lip, ear-ear, etc.) are resolved prior to generating the volumetric mesh. For example, self-intersections may be resolved by starting from an intersection-free template mesh, then optimizing the mesh to match a possibly non-intersections-free patient-specific target shape as closely as possible while preserving the absence of self-intersections by simulating contact potential responses. The algorithm may minimize a weighted combination of the cost functions, such as difference-to-target (e.g. squared L2 norm of difference of vertex positions between current and target and/or ARAP-based energy to model difference in shape) and potential contact barrier functions (e.g., incremental potential contact (IPC), implicitly moving least-squares (IMLS)-based, etc.).

In at least one embodiment, a 3D skin model and a 3D skull model may be used to generate a soft-tissue representative volumetric mesh with finite elements that allow for simulation. For example, the interface between bone from the 3D skull model and soft-tissue from the 3D skin model can be modeled by zero-displacement Dirichlet boundary conditions, by allowing the soft-tissue to slide along the bone surface (sliding contact interface), or a combination of both. Skin can be modeled by fixing the 3D skin model to an outer surface of the soft-tissue representation and allowing it to slide on the soft-tissue. In at least one embodiment, material parameters of the volumetric mesh can be obtained from one or more of the following: a fixed distribution of known parameters (e.g., known or estimated Poisson's ratio and Young's modulus of human skin, fat, muscle, ligaments, etc.); from a non-patient-specific (i.e., a general human head) distribution of parameters (optimized using differentiable simulation), or joint optimization on a dataset of different patients with multiple expressions/articulations; or from a patient-specific distribution of parameters (optimized by using differentiable simulation with, for example, multiple 3D face scans or a 3D face video of the patient performing different facial expressions and/or articulations).

In at least one embodiment, sliding contact between teeth and soft-tissue is considered in the simulation. Potential contact can be modeled using a C2 continuous log barrier function (e.g., IPC or IMLS surface of the tooth mesh as a distance metric). This approach also allows for simulation of contact in differentiable-simulation applications. In the simulation, teeth can be moved according to a treatment plan's articulation goals while considering contact with the soft-tissue.

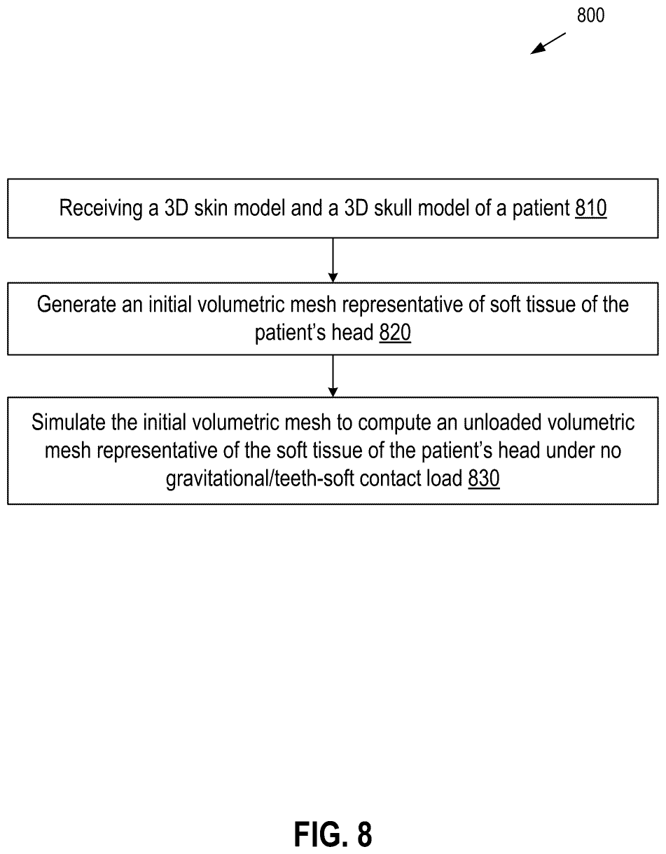

In at least one embodiment, one or more finite element simulations may be used to simulation motion of the volumetric mesh. Finite element simulation generally requires a neutral, stress-free reference state describing the soft tissue at rest (i.e., without any forces acting on it). Since the input data 702 does not include any direct information on the inner mouth region (intraoral cavity), the rest shape (and/or per-element pre-stretch material parameters) of the volumetric mesh can be optimized such that the shape in static equilibrium (before treatment) of the inner mouth (intraoral cavity) does not intersect with teeth, but ideally is in resting contact. The static equilibrium state (before treatment) has realistic forces acting between teeth and soft-tissue (and vice-versa). Specifically, the contact forces should be such that removing the teeth results in a realistic (or at least visually plausible) soft-tissue collapse (similar to removing dentures for edentulous patients). In at least one embodiment, the initial state of the volumetric mesh may be simulated under gravity-free loading to identify an initial state that is unaffected by gravity (referred to as a “free volumetric mesh”). A methodology for computing the free volumetric mesh is described with respect to FIG. 8.

In at least one embodiment, as a starting point for the optimization, (1) the intersection-free patient-specific volumetric mesh (e.g., a template fitted to patient-specific face and bones) gives an initial guess on the shape of the inside of the patient's mouth. By design, the template fitted to the patient-specific face and bones has an intraoral cavity with reduced volume, i.e., enlarged soft-tissue thickness in the lips and cheeks region. (2) The soft-tissue surface mesh can be used with volumetric meshing methods (e.g., tetrahedralization algorithms, hexahedral meshing algorithms, etc.) to generate a volumetric soft-tissue mesh that comprises finite elements (of possibly a combination of different types such as tetrahedral, prismatic, hexahedral, etc.). (3) In a next step, a physically based simulation is used to insert the teeth into the intraoral cavity and position them correctly. The simulation takes into account teeth-soft contact, resulting in a deformed soft-tissue shape where the lips and cheeks are pushed outward to accommodate the teeth. The soft tissue is now in a state of resting contact with the teeth. (4) Differentiable simulation is used to solve the inverse problem where the rest shape is optimized such that the resulting deformed static-equilibrium state minimizes an objective function, for example, as described in Zehnder et al., “Sparse Gauss-Newton for Accelerated Sensitivity Analysis,” ACM Transactions on Graphics (TOG), 41(1), pp.1-10. Suitable objective functions consider the distance between outer face shape of the actual shape and simulated deformation. An optional objective can be added that considers the distance between the upper and lower lip. This optimization results in a soft-tissue simulation mesh that is optimized for dental treatment simulation. Treatment simulation can start from a static equilibrium state where the oral mucosa is in resting contact with the teeth and even slight tooth movement or mandible movement can result in corresponding facial soft-tissue changes.

In at least one embodiment, orthodontic treatment planning can be modeled by a rigid transformation for each individual tooth, and/or a rigid transformation for the mandible. Orthodontic treatment usually leads to a change in bite which can be modeled by an additional rigid transformation that is applied to the mandible and all lower teeth. In at least one embodiment, this rigid transformation can either be specified by (1) the treatment plan, (2) not explicitly specified, but simulated by considering the contact between lower and upper teeth (and some force/muscle that acts on the mandible in the upward direction and anatomically plausible constraints, such as constraint transformations to be rotations around the hinge axis, in the temporomandibular area), or given by an articulator model (e.g., open mouth) that may optionally be patient-specific.

In at least one embodiment, a restorative or prosthodontic treatment applied to the virtual patient, such as dentures, veneers, crowns, bridges, implants, etc., can be represented by a 3D mesh. Such meshes can be placed at their correct position inside of the 3D skull model (e.g., correct relative position to intraoral scan data or the 3D skin mesh). Contact with soft-tissue (intraoral mouth cavity) and restorative treatment materials can then be simulated.

In at least one embodiment, an orthognathic surgery treatment on the virtual patient, can be modeled by either cutting the maxilla and mandible of a 3D skull model into multiple individual parts and rigidly displacing them according to the treatment plan, or by non-rigidly deforming mandible/maxilla shape of the 3D skull model such they fit the treatment plan objectives.

In at least one embodiment, the volumetric mesh of the virtual patient can be used to model muscle activation (based on simulation parameters) from a set of different expressions given by one or more of multiple 3D facial scans, a 3D face video, retargeting expressions from a parametric head mesh to the volumetric mesh, or by simulating muscle activations.

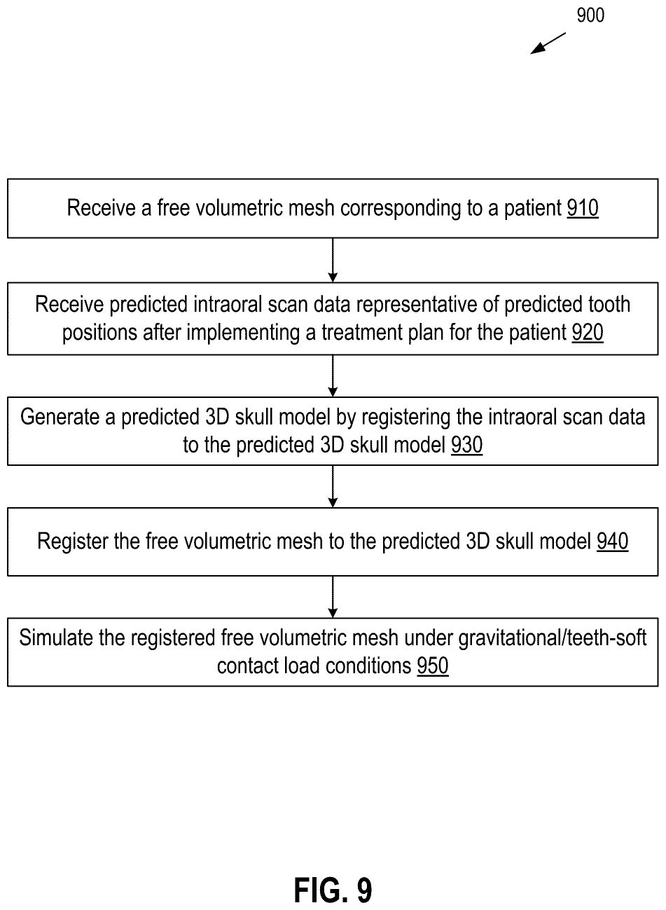

FIGS. 8 and 9 are flow diagrams illustrating exemplary methods 800 and 900, respectively, of generating and/or utilizing a volumetric mesh representative of soft tissue of the virtual patient's head, in accordance with at least one embodiment. The methods 800 and 900 may be implemented as part of the tissue optimization workflow 220, and may be performed by a processing logic that may comprise hardware (e.g., circuitry, dedicated logic, programmable logic, microcode, etc.), software (e.g., instructions run on a processing device to perform hardware simulation), or a combination thereof. In at least one embodiment, at least some operations of the methods 800 and 900 are performed by a computing device executing a dental modeling application, such as the simulation logic 118 of FIG. 1.

Referring now to the method 800 of FIG. 8, at block 810, the computing device receives a 3D skin model and a 3D skull model of a patient. In at least one embodiment, the 3D skin model may be derived from facial scan data of the patient, using methodologies described with respect to the pipeline 400. In at least one embodiment, the 3D skull model comprises an estimated 3D skull model (e.g., estimated based on or derived from the 3D skin model), which may be computed from the skull estimation workflow 210 described with respect to the pipeline 400. In other embodiments, one or more of the 3D skin model or the 3D skull model may be derived from the same data set for the patient, such as CBCT scan data, for example, by a segmentation algorithm. In at least one embodiment, the computing device further receives intraoral scan data comprising a 3D teeth model representative of the patient's teeth and gingiva structure.

At block 820, the computing device generates an initial volumetric mesh representative of soft tissue of the patient's head. In at least one embodiment, the initial volumetric mesh is an unloaded volumetric mesh representative of an unloaded state of the soft tissue of the patient's head. For example, the term “unloaded state” can refer to a state under which the soft tissue experiences no contact with teeth (“teeth-soft contact”), no gravitational load, or both. In at least one embodiment, if the 3D skin model and the 3D skull model are not aligned to each other, the computing device may register the 3D skin model to the 3D skull model, which may be based at least in part on facial landmarks. In at least one embodiment, the computing device generates the initial volumetric mesh based on tissue volume estimated to occur within the volume between the 3D skin model and the 3D skull model. In at least one embodiment, the initial volumetric mesh may further comprise representations of stiffness variations in the soft tissue of the patient's head (e.g., greater stiffness for soft tissue of the nose versus the cheek).

At block 830, the computing device simulates the initial volumetric mesh under stress-free (unloaded) conditions to compute a free volumetric mesh. The free volumetric mesh may be representative of the soft tissue of the patient's head under no load (e.g., gravitational load, sliding contact interface-based load, etc.) (a “rest shape” of the volumetric mesh). In at least one embodiment, simulating the initial volumetric mesh under unloaded conditions comprises applying one or more of differential analysis or a finite element solver to the initial volumetric mesh. In at least one embodiment, the simulation comprises performing a differentiable simulation-based optimization to optimize the unloaded volumetric mesh.

In at least one embodiment, the computing device simulates the initial volumetric mesh by generating a plurality of candidate volumetric meshes based on the initial volumetric mesh. Each of the candidate volumetric may represent test meshes that correspond to the rest shape of the volumetric mesh unloaded. In at least one embodiment, differential analysis or a finite element solver may be applied to the candidate meshes to simulate the mesh under load. The computing device may then selected one of the candidate meshes as the free volumetric mesh that most accurately simulates the physics of the patient's face under load.

In at least one embodiment, a photorealistic deformable 3D model of the patient's head may be computed according to the photorealistic rendering workflow 230 (described in greater detail with respect to the method 1200), for example, using differentiable volumetric rendering (e.g., NeRF modeling or 3D Gaussian splatting).

In at least one embodiment, the volumetric mesh resulting from the tissue optimization workflow 220 is deformable such that it can be used in downstream simulations to predict changes in the patient's face responsive to a dental treatment plan. In at least one embodiment, the volumetric mesh can be simulated to predict changes to the patient's face responsive to simulations of bone growth, aging, or weight gain or loss. In at least one embodiment, the volumetric mesh is deformable to simulate and predict changes to the patient's face responsive to aesthetic treatments (e.g., filler injection). An exemplary embodiment relating to dental treatment planning is described by the method 900.

Referring now to the method 900 of FIG. 9, at block 910, the computing device receives a free volumetric mesh, for example, corresponding the free volumetric mesh computed according to the method 800.

At block 920, the computing device receives intraoral scan data representative of predicted tooth positions (in upper and lower dental arches) after implementing a treatment plan for the patient. At block 930, the computing device generates a predicted 3D skull model by registering the intraoral scan data to the predicted 3D skull model. For example, the computing device utilize methods similar to those described with respect to the skull estimation workflow 210 to transform/deform a 3D skull model.

At block 940, the computing device registers the free volumetric mesh to the predicted 3D skull model, and at block 950 the computing device simulates the registered free volumetric mesh under gravitational load conditions. The simulated volumetric mesh can be used as an estimate/prediction of the patient's post-treatment facial shape after implementing the treatment plan. In at least one embodiment, a user interface may be presented showing a volumetric mesh (representative of the patient's current facial structure) together with the predicted volumetric mesh (representative of the patient's post-treatment facial structure).

In at least one embodiment, texture (color) can be transferred from the input 3D facial scan data to the volumetric mesh. Simulated deformations can be retargeted to a higher resolution 3D facial mesh, a different 3D facial mesh used for rendering/visualization, input 3D facial scan data, or a volumetric representation of the patient's head (e.g., a photorealistic deformable NeRF/3DGS (or any other differentiable volumetric rendering) model, as described below with respect to the photorealistic rendering workflow 230). In at least one embodiment, animations and/or images of the patient-specific volumetric mesh or a retargeted mesh can be rendered (e.g., via rasterization, ray-tracing, volumetric rendering, ML methods in image space, or a combination thereof) from different view points to visualize before and after treatment soft tissue deformations, teeth movement, bite changes, etc. In at least one embodiment, visualization can be animated further by moving the mandible according to an articulator model, simulating eye movement, or changing facial expressions.

The exemplary photorealistic rendering workflow 230 is now described, which provides methods for photorealistic rendering of a patient's face, for example, to improve visualization of predicted facial structure resulting from orthodontic, restorative, and/or orthognathic surgery treatment. In at least one embodiment, a method comprises receiving multiple images of a patient's face obtained from a facial scan, which may comprise individual images captured of the patient's face or image frames derived from a video of the patient's face. The facial scan may be performed as described in U.S. Non-Provisional patent application Ser. No. 18/239,712. The method then utilizes differentiable volumetric rendering modeling of the data to generate a photorealistic and deformable neural representation of the patient's face.

Differential volumetric rendering modeling may utilize a deep learning architecture for reconstructing a 3D representations of a scene from 2D images (NeRF). An inherent challenge faced by volumetric rendering methods lies in incorporating mesh-based deformations. The present embodiments address these challenges by implementing deformable volumetric rendering models to achieve precise 3D facial deformations, based on the capture of a single expression (e.g., a static subject). Certain embodiments introduce a learnable and nonlinear N-dimensional deformation space, facilitating the synthesis of novel facial expressions and shapes. By integrating a mesh shaped to mirror the patient's facial volumetric representation, with a higher-dimensional space defined by blendshape models or deformation parameters, the embodiments enable a volumetric deformation learning model to learn from rendered images (of a mesh under deformation) and visualize intricate facial deformation spaces. In at least one embodiment, an MLP architecture is used that is based on a series of cascading MLPs. In at least one embodiment, a first MLP deforms space, and the subsequent MLPs provide density and color, such that the MLP architecture is optimized for interchangeability of deformation and high-resolution photorealistic quality. These properties can be advantageous for diverse applications, ranging from digital entertainment to medical simulations, where the realistic portrayal of human emotion, expression, and precise face shapes is desired. An alternative approach can directly deform the volumetric rendering model based on a set of aligned surface meshes (e.g., outputs of dental treatment soft-tissue simulation).

Given facial scan data, differentiable volumetric rendering can be used to train a model (e.g., volumetric radiance fields, 3DGS, etc.) such that input views are matched as closely as possible while also generalizing photorealistic rendering to novel views, thus allowing for the patient's face to be photorealistically rendered from many different positions and angles. In at least one embodiment, 3D facial mesh deformations can be retargeted to the photorealistic model (e.g., NeRF, 3DGS, etc.) by learning the spatial deformation (e.g, using a separate deformable NeRF model), or by computing deformations using an appropriate interpolation method for any position that is not part of the 3D facial mesh. In at least one embodiment, if the patient's teeth are visible, tooth displacements and/or deformations can be retargeted to the photorealistic model as well.

The photorealistic rendering workflow 230 thus allows for rendering of photorealistic images: (1) from different views; (2) from simulated/learned soft tissue deformations resulting from orthodontic, restorative, or orthognathic surgery treatments; (3) of rigid teeth movement given by orthodontic treatment plans; (4) from non-rigid teeth shape deformation given by restorative treatment plans; (5) of simulated/learned tooth color changes resulting from teeth whitening treatment; (6) of simulated/learned soft tissue changes resulting from controlled articulation; (7) of simulated/learned soft tissue changes resulting from controlled changes in expression; (8) of simulated/learned soft tissue changes resulting from natural facial motions (breathing, blinking, microexpressions, small eye movement, etc.); or (9) of simulated/learned soft tissue changes resulting from growth that are aligned with a patient's intraoral scan data, 3D facial scan data, CBCT scan data, or estimated 3D bone meshes (e.g., generated from the skull estimation workflow 210). In at least one embodiment, a volumetric rendering viewer can be used to inspect a photorealistic volumetric model (such as a “NeRF model” or “3DGS model”) in real time. The interactive viewer can provide controls to adjust visualization modes (before, after, superimposition, blending, morphing), treatment parameters, articulation, and other animation controls.

This photorealistic rendering workflow 230 can further be used for a fully differentiable simulation-rendering pipeline, for example: (1) using multiple face sweeps of different expressions we can optimize material properties and muscle activation simulation parameters such that different expressions are matched as closely as possible; (2) using a single face sweep of the articulating patient, accounting for time variable and deforming face, and optimizing a patient-specific articulation model; or (3) optimizing orthodontic, restorative and/or orthognathic surgery treatment parameters, such that volumetric rendering matches a specified target (e.g., modeled 3D shape, hand clicked landmarks, drawn contour, etc.) as closely as possible.

In digital dentistry applications, advanced imaging technologies and 3D scanners can be used to capture detailed patient-specific geometry. For example, a CBCT head scan, 3D facial scan, 3D intraoral scan, can be used to construct a 3D virtual patient model that provides a precise representation of the patient's soft tissue, teeth, and skeletal structures. Such a 3D digital counterpart can serve as a foundation for accurate diagnosis, dental treatment planning, and physically-based simulation. Potential outcomes of orthodontic movements, restorative procedures, and surgical interventions can be visualized, and feasibility, effectiveness, and potential challenges of the proposed treatment plan can be assessed before its implementation. To simulate the facial soft-tissue deformations resulting from dental treatments, the patient's soft tissue can be modeled using solid finite elements (e.g., linear tetrahedra) and a neo-Hookean material model. As an example, the outcome of an orthodontic treatment can be simulated by moving the patient's teeth according to the treatment plan while considering contact between teeth and soft-tissue. In addition, changes to the patient's bite can be simulated by displacing the mandible according to the planned treatment.

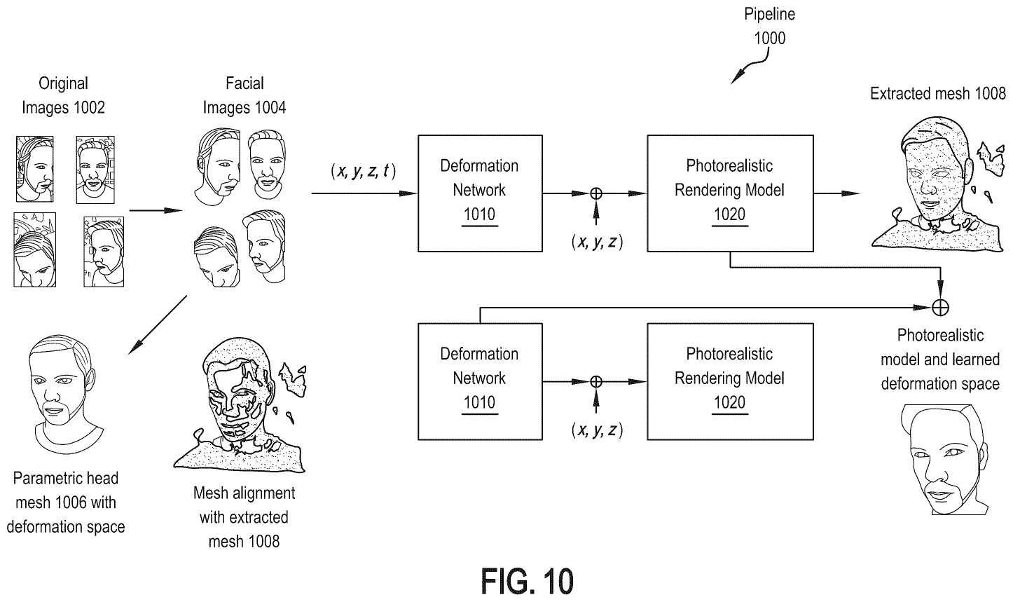

FIG. 10 illustrates an exemplary pipeline 1000 for generating photorealistic and deformable models (e.g., NeRF, 3DGS, etc.), in accordance with at least one embodiment. As illustrated, the pipeline receives original images 1002 of the patient's face as input, from which facial images 1004 are generated via background removal. In at least one embodiment, the original images are directly used as the facial images, where the background can later be removed by constraining the scene depth. In at least one embodiment, the original images 1002 are preprocessed to eliminate the background before initiating training of the volumetric radiance field/3DGS learning model, which can be achieved, for example, using a green screen during image capture of through deep learning-based segmentation. In an exemplary use case, approximately one hundred images are captured using a smartphone, taken at angles ranging from −45 to +45 degrees from the center of the patient's face, though other angles, numbers of images, and camera hardware are contemplated.

In at least one embodiment, a 3D facial mesh is computed from the original images 1002, for example, using photogrammetry. This constructed mesh is then fitted with a parametric head mesh 1006 (e.g., a FLAME mesh as described in Li et al., “Learning a model of facial shape and expression from 4D scans,” ACM Trans. Graph. 36.6 (2017): 194-1). Subsequently, the parametric head mesh 1006 is used to build a deformable mesh space. In at least one embodiment, the deformable mesh space is based on an FEM simulator with multiple input dimensions, based on a linear combination of blendshapes, or based on a one-dimensional mesh sequence where the parametric head mesh 1006 is used as the initial state.

In at least one embodiment, a photorealistic rendering model 1020 is trained based on the facial images 1004 to obtain a photorealistic representation of the patient's face. In cases where the facial images 1004 include a background, photorealistic rendering model 1020 can be trained with additional module that learns to represent the background on a sphere. The MLP of the photorealistic rendering model 1020 is queried by intersecting a ray with a surrounding sphere, determining the location on the sphere, and subsequently producing a color. For the final visualization, this background model can be disregarded and substituted with white. For example, areas with a transparent background are masked and replaced with a white background.

The parametric head mesh 1006 (which is based on the facial images 1004) is used to generate training data for the deformation network 1010. To ensure a precise alignment of the photorealistic representation with the parametric head mesh 1006 in its initial state (before deformation), the parametric head mesh 1006 is aligned with a volumetric model extracted from the photorealistic rendering model 1020 (extracted mesh 1008). In at least one embodiment, the extracted mesh 1008 is generated by running a marching cubes algorithm inside an axis-aligned bounding box that contains the face of the subject.

In at least one embodiment, an iterative closest point method is used to scale, rotate, and position the extracted mesh 1008 to ensure alignment with the parametric head mesh 1006. With this alignment, the deformation space can be learned by continuously rendering small batches of images of the deformed parametric head mesh 1006 from various angles and using different deformation parameters. Once the deformation network 1010 is trained, the learned deformation can be transferred to the photorealistic rendering model 1020, given the alignment of both representations. The final volumetric model can then visualize the learned deformation space on a photorealistic rendition of the patient's face. In at least one embodiment, the architecture of the pipeline 1000 is based on Instant-NGP.

In at least one embodiment, to convert deformation space into a volumetric rendering model (NeRF/3DGS), multiple batches of frames (e.g., 50 frames) are continuously rendered, which the deformation network 1010 encounters every few epochs. These frames may utilize randomly sampled camera positions from a section of a hemisphere, which also has a randomly sampled radius, encompassing the frontal part of the patient's face. In at least one embodiment, n dimensions of the deformation space are randomly sampled. These sampled dimensions can range between zero and one, with zero indicating no deformation for that specific dimension. For 1D deformation spaces, such as those based on time, the sampled times can be rounded to the nearest frame. In at least one embodiment, the deformation network 1010 can be trained to display the entire deformation space.

Generally, the deformation network 1010 operates independently from the photorealistic rendering model 1020. The deformation network 1010 produces an XYZ displacement of space, which can then be applied to the input sample position of another density network. The deformation can be learned based on the volumetric model (which encompasses a NeRF or 3DGS model, density, and color) that was originally used to capture the deformation space (e.g., the extracted mesh 1008) of the parametric head mesh 1006. By applying this learned deformation to the input of the photorealistic rendering model 1020, a resulting photorealistic model is deformable and can enable visualization of the deformation space associated with it.

A one-dimensional (1D) deformation space is exemplified by the pipeline 1000, which is represented as a time-based sequence of meshes. To construct an N-dimensional deformation space, distinct blendshapes can be created to allow for adjustment of facial features like the curvature of a smile or the position of the eyebrows. Each blendshape can be controlled by a single parameter, allowing for linear interpolation between blendshapes to generate a range of deformations. This approach can serve as the basis for the deformation space in various embodiments.

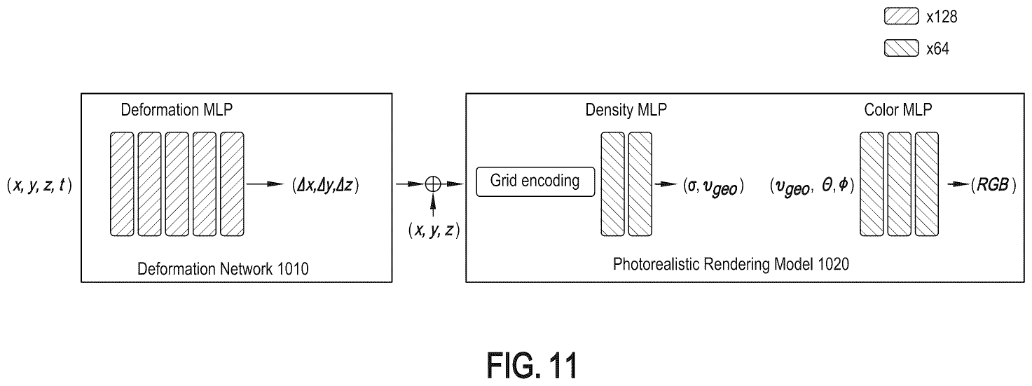

FIG. 11 illustrates the components of an exemplary NeRF architecture, in accordance with at least one embodiment. As illustrated, the NeRF architecture includes three MLPs: a deformation MLP (deformation network 1010), and density and color MLPs (photorealistic rendering model 1020). In at least one embodiment, this same NeRF architecture throughout the entire pipeline 1000, though other architectures are contemplated. The initial MLP of deformation network 1010 serves as a deformation network, which takes the sample's position as input, along with n additional dimensions. For a 1D scenario, the additional dimension could represent time. In at least one embodiment, the deformation network 1010 captures the deformation space influenced by the blendshapes or other deformation sources on the parametric head mesh 1006. Additionally, in the context of the photorealistic NeRF, the deformation network 1010 discerns subtle deformations present in the patient's images. In at least one embodiment, the inputs undergo frequency encoding across ten levels to capture finer deformations.

Following the deformation MLP, the density MLP accepts the sample position, which is displaced on the x, y, and z axes based on the output from deformation network 1010. In at least one embodiment, the output of the density MLP comprises a density value and a geometric feature vector, which provides information about a point's location within the density. In at least one embodiment, grid encoding (e.g. tiled grid-based encoding) is performed on the input to the density MLP to improve training speed and approximation quality.

In at least one embodiment, the color MLP receives view direction and the geometric feature vector as inputs, and generates an RGB color as its output. In at least one embodiment, final pixel color is computed based on volumetric rendering. In at least one embodiment, the photorealistic rendering model 1020 is trained using mean squared error against ground truth images. In at least one embodiment, a regularization loss is incorporated into the training to encourage the deformation network to default to zero output to mitigate deformation artifacts.

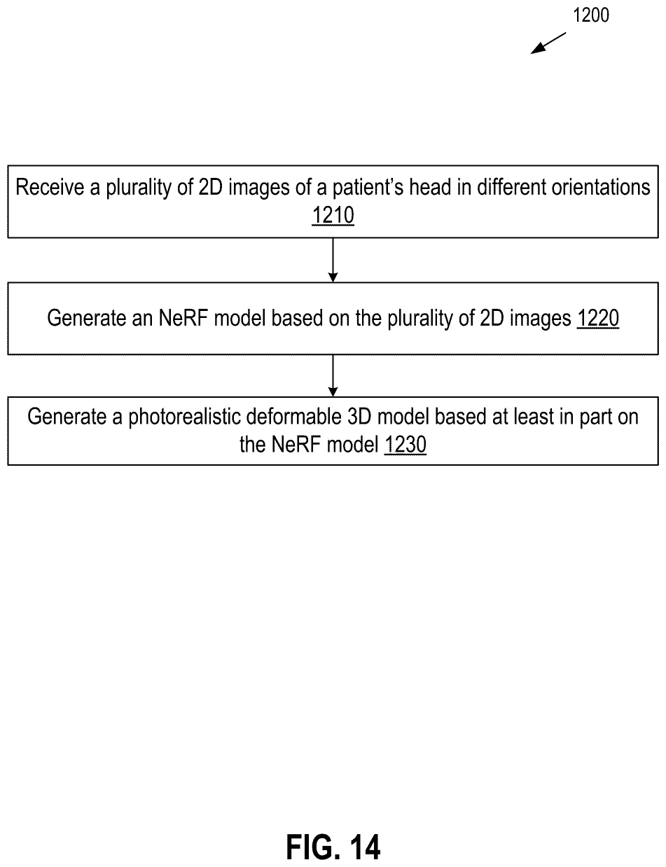

FIG. 12 is a flow diagram illustrating an exemplary method 1200 of generating a photorealistic deformable 3D model of a patient's head via differentiable volumetric rendering modeling, in accordance with at least one embodiment. The method 1200 may be implemented as part of the photorealistic rendering workflow 230, and may be performed by a processing logic that may comprise hardware (e.g., circuitry, dedicated logic, programmable logic, microcode, etc.), software (e.g., instructions run on a processing device to perform hardware simulation), or a combination thereof. In at least one embodiment, at least some operations of the method 1200 are performed by a computing device executing a dental modeling application, such as the simulation logic 118 of FIG. 1.

Referring now to the method 1200 of FIG. 12, at block 1210, the computing device receives a plurality of 2D images of the patient's head in different orientations.

At block 1220, the computing device generates a differentiable volumetric rendering model (e.g., a NeRF model or a 3DGS model) based on the plurality of 2D images. In at least one embodiment, the plurality of 2D images are obtained from a video of the patient's head in the different orientations. For example, the plurality of 2D images may comprise about 50, 60, 70, 80, 90, 100, 110, 120, 130, 140, 150, 160, 170, 180, 190, 200, any range defined therebetween, or greater than 200 images of the patient's head.

In at least one embodiment, generating the differential volumetric rendering model comprises utilizing an differential volumetric rendering architecture (e.g., a NeRF architecture) comprising a cascading series of MLP architectures. For example, generating the differential volumetric rendering model may utilize the deformation network 1010 and photorealistic rendering model 1020 MLP architectures in a cascading configuration (e.g., as illustrated by the pipeline 1000 showing deformation network 1010 and photorealistic rendering model 1020). In at least one embodiment, the cascading series of MLP architectures comprises a deformation-based MLP architecture representative of deformation space, a density-based MLP architecture representative of density space, and a color-based MLP architecture representative of color map space.

At block 1230, the computing device generates the photorealistic deformable 3D model based at least in part on the differential volumetric rendering model. In at least one embodiment, the differential volumetric rendering model has an associated visualization space. In at least one embodiment, the computing device generates an aligned differential volumetric rendering model by aligning the differential volumetric rendering model with a deformable mesh representative of the patient's head. In at least one embodiment, the aligned differential volumetric rendering model has an associated deformation space. In at least one embodiment, the photorealistic deformable 3D model is generated based further on the aligned differential volumetric rendering model, such that the resulting photorealistic deformable 3D model is associated with the visualization space and the deformation space. In at least one embodiment, the photorealistic deformable 3D model is generated based further on the aligned differential volumetric rendering model, such that the photorealistic deformable 3D model has associated therewith the visualization space and the deformation space.

In at least one embodiment, the computing device generates an initial 3D mesh from the plurality of 2D images via photogrammetry, and generates the deformable mesh by fitting a pre-defined model derived from a database of aligned 3D scans of human faces.

In at least one embodiment, the computing device generates an initial 3D mesh from a volumetric mesh representative of soft tissue of a patient's head. The computing device may further generate the deformable mesh by fitting a pre-defined model derived from a database of aligned 3D scans of human faces (e.g., the parametric head mesh 1006). In at least one embodiment, the computing device trains a volumetric radiance field learning model based on the deformable mesh.

In at least one embodiment, the computing device generates a predicted differential volumetric rendering model based at least in part on a predicted 3D skin model of the patient's head computed based on a simulation of a dental treatment plan. A predicted photorealistic deformable 3D model can subsequently be generated based at least in part on the predicted differential volumetric rendering model.

In at least one embodiment, teeth of the patient are visible within the plurality of 2D images, and the photorealistic deformable 3D model can be deformable based on simulated displacements in the teeth.

In at least one embodiment, the computing device presents for display by a display device a real-time interactive volumetric rendering (e.g., where camera pose is controllable) of the photorealistic deformable 3D model for visualization.

The exemplary image enhancement workflow 240 is now described, which relates to methods for improving or enhancing the appearance of extra-oral patient images (e.g., facial images) and generating interpolated 2D images or interpolated 3D models for illustrating changes to the patient's face, such as interpolating between a patient's relaxed face and smiling face. In at least one embodiment, the image enhancement workflow 240 can accept additional user input to determine regions of interest and strength of enhancement/correction applied to it. The image enhancement workflow 240 can also run fully automatically to discover and enhance regions for which digital correction is appropriate.

Face restoration covers a broad range of image issues ranging from compression artifacts, grain artifacts, motion blur, defocused parts of images, color and lighting problems, as well as unwanted/unusual issues such as blemishes on faces. Current approaches do not enhance the images apart from the simulation in the inner-mouth region. To conceal or correct skin issues, makeup could be applied directly on the patient's skin before being captured either for extra-oral images or 3D facial scans. The present embodiments advantageously conceal and correct skin issues virtually without additional preparation steps being needed before scanning the patient.

Although outputs the photorealistic rendering workflow 230 can be photorealistic, the extra-oral (e.g., facial) components could nevertheless have temporary skin conditions (e.g., acne, pimples, sunburns). Moreover, the image might have further problems such as lighting/color issues or motion blur that might prevent algorithms from running correctly. Thus, the embodiments described with respect to the image enhancement workflow 240 can be used to post-process visual data generated by the modeling pipeline or other by other machine learning models. This is advantageous in particular for machine learning models that generally do not produce high resolution images, contain artefacts, or are blurry.

In at least one embodiment, input data may be preprocessed to improve performance of the downstream models/methods by improving data quality. Preprocessing operations may include upscaling low resolution input photos/videos before inputting them to machine learning pipelines trained on data with higher resolution.

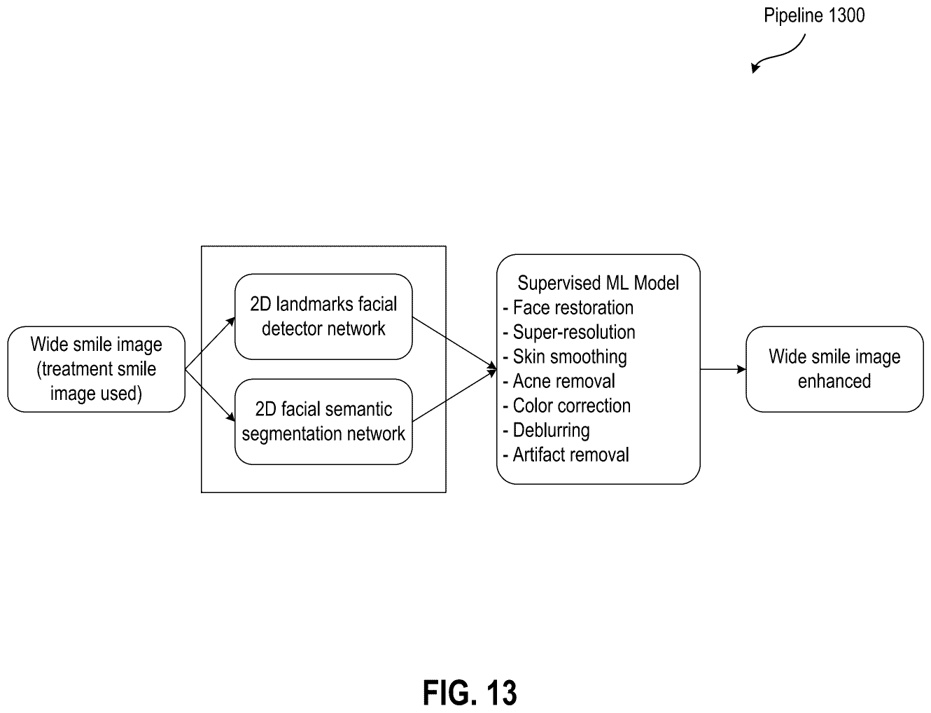

FIG. 13 illustrates an exemplary pipeline 1300 for enhancing an 2D image. Although it is discussed within the context of “wide-smile” images of a patient, the pipeline 1300 may be used for other facial expressions of a patient captured in a 2D image. In at least one embodiment, the input image is inputted in parallel into a 2D landmarks facial detector network (also referred to as a “facial landmark detection model”) and a 2D facial semantic segmentation network (also referred to as a “facial semantic segmentation model”).

In at least one embodiment, the facial landmark detection model may utilize a machine learning model, such as a deep learning model, for facial landmark detection within the input image. Landmark detection, generally, includes identifying landmarks in images. Facial landmarks may be particular types of features, such as centers of teeth in at least one embodiment. In at least one embodiment, 2D facial landmark detection may be used to identify various facial features, such as eyes, nose, nostrils, lips, ears, teeth, and blemishes within a 2D image. In at least one embodiment, landmark detection is performed after dental object segmentation. In at least one embodiment, dental object segmentation and landmark detection are performed together by a single machine learning model. In at least one embodiment, one or more stacked hourglass networks are used to perform landmark detection. One example of a model that may be used to perform landmark detection is a convolutional neural network that includes multiple stacked hourglass models, as described in Alejandro Newell et al., Stacked Hourglass Networks for Human Pose Estimation, Jul. 26, 2016, which is hereby incorporated by reference herein in its entirety.

In at least one embodiment, the facial semantic segmentation model may utilize a machine learning model, such as a deep learning model, to identify “segmentation elements” in which multiple objects of the same class are treated as a single entity. For example, all features linked to a segmentation element label of “teeth” can be identified as teeth, all features linked to a segmentation element label of “interproximal spaces”, can be identified as interproximal spaces, and all features linked to a segmentation element label of “gingiva” can be identified as gingiva. Furthermore, the facial semantic segmentation model may be trained to construct an instance segmentation network to identify “segmentation elements” in which multiple objects of the same class are treated as distinct individual objects or instances. In an exemplary embodiment, the image-based network, Mask RCNN comprises a region proposal network, an instance classifier, and an instance mask. This style of network can be implemented with a sparse voxel 3D representation that results in a network that accurately finds a 3D mask of each facial feature and classifies each facial feature. Alternatively, each instance proposal could be classified with a separate approach. In this scenario, the 3D model can be segmented using an instance segmentation combined with an instance classification.

In at least one embodiment, the output from the models may be used as input to a further machine learning model, such as a supervised machine learning model that is trained to perform one or more image enhancements. The image enhancements may be selected from, but not limited to: face restoration, increased resolution, skin smoothing, acne removal, color correction, deblurring, or artefact removal.

While the image enhancement can be performed on images with “wide smile” facial expressions of the patient, these types of images generally appear unnatural and are often not aesthetically pleasing. While the expression is helpful for improving the performance of the image enhancing algorithms described herein, the results do not represent the optimal smile of the patient. In this context, the term “optimal smile” can be considered as the patient's natural smile. Further embodiments of the methodologies of the photorealistic rendering workflow 230 can utilize wide smile facial expressions and relaxed facial expressions to interpolate between the two to identify an optimal smile for the patient.

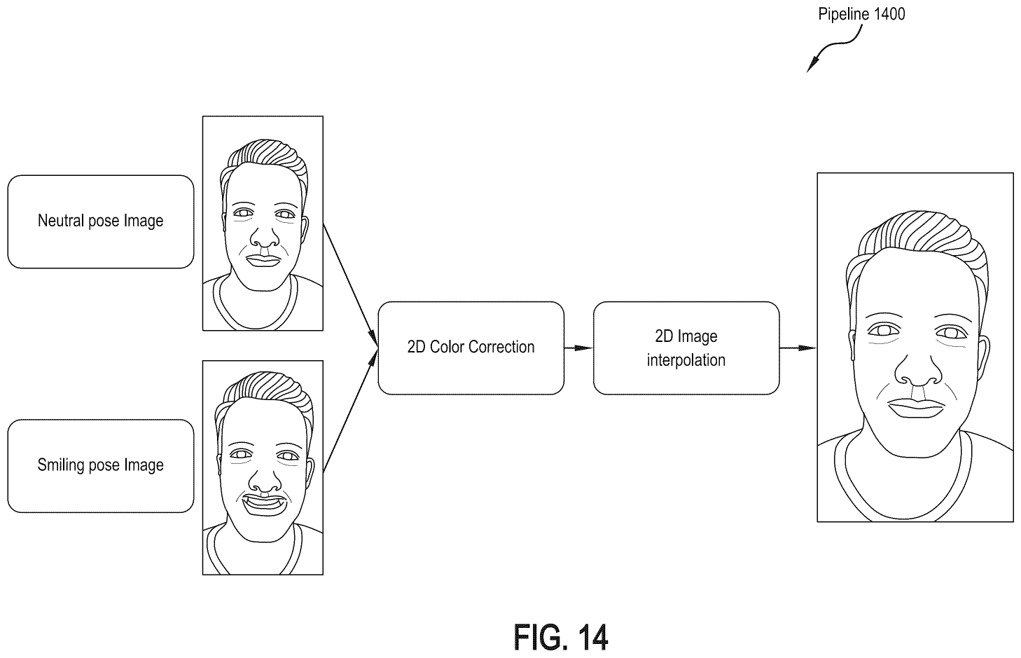

FIG. 14 illustrates an exemplary pipeline 1400 for performing image interpolation on 2D images, in accordance with at lease one embodiment. In at least one embodiment, the pipeline 1400 receives two images: a first image of the patient in a neutral pose (a relaxed facial expression) and a second image of the patient with a wide smile such that the patient's teeth are substantially shown. In at least one embodiment, a 2D color correction operation is applied to the two images. For example, the color correction operation may be a color transfer operation that modifies the colors of the images so that colors match and/or are aligned between the images. Such color transfer operations are described in U.S. patent application Ser. No. 18/496,743, filed on Oct. 27, 2023, which is hereby incorporated by reference herein in its entirety.

In at least one embodiment, a 2D image interpolation (or “frame interpolation”) is performed on the color corrected images. The frame interpolation may be performed using a learned hybrid data driven approach that estimates movement between images to output images that can be combined to form a visually smooth transition even for irregular input data. The frame interpolation may also be performed in a manner that can handle disocclusion, which is common for open bite images. One or more of the operations of the pipeline 1400 may be performed using machine learning models, such as neural networks, which may be used to perform other operations such as key point detection, segmentation, style transfer, and/or image generation. Frame interpolation operations are further described in U.S. patent application Ser. No. 18/496,743.

In at least one embodiment, additional interpolated images may be generated. The interpolated images can be generated in a manner such that they are aligned with the captured images in color and space. The modified images and synthetic images are then used to generate a video, where each of the images may be a frame of the video. The video may then be presented to a doctor, patient, etc. to clearly and smoothly show different versions of the patient's smile to identify an optimal smile.

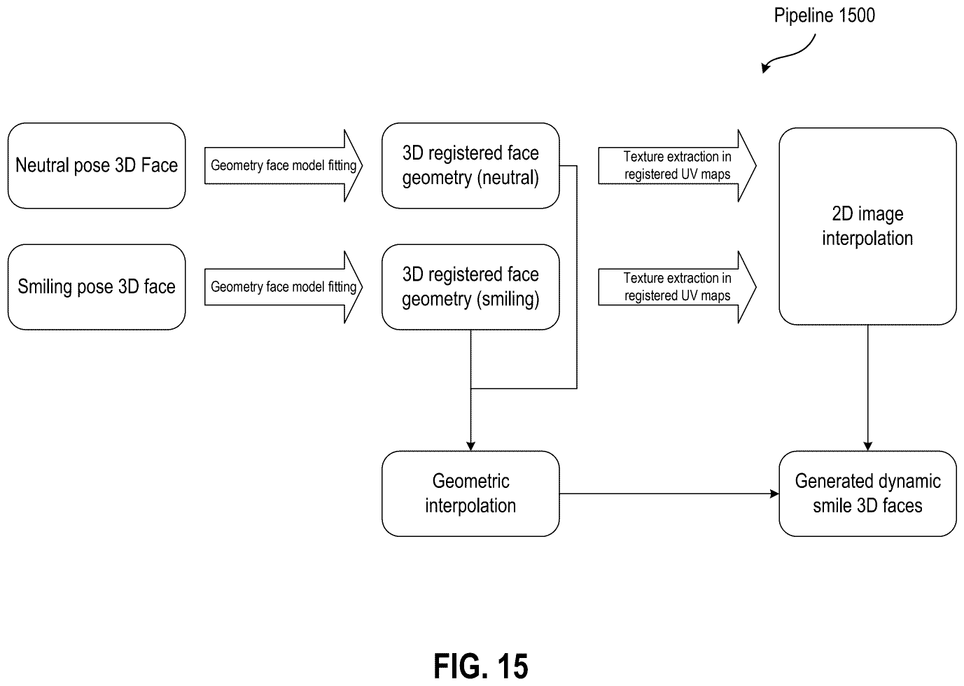

FIG. 15 illustrates an exemplary pipeline 1500 for performing interpolation on 3D models, in accordance with at lease one embodiment. In at least one embodiment, the pipeline 1500 receives 3D facial scan data representative of the patient's face in a neutral pose, and 3D facial scan data representative of the patient's face in a wide smile pose. For each set of data, 3D skin meshes may be generated from each as described in various embodiments herein. In at least one embodiment, each of the 3D skin meshes are registered to deformable parametric head meshes. For example, the neutral pose 3D skin model is registered to a neutral pose parametric head mesh, and the wide smile 3D skin model is registered to a wide smile parametric head mesh. Next, each of the registered skin/parametric meshes is subjected to a geometric interpolation operation based on a target degree of interpolation. In parallel, 2D texture maps are extracted from each of the skin/parametric meshes, and are subjected to a 2D image interpolation (e.g., via the pipeline 1400) to obtain an interpolated texture map. Finally, the interpolated texture map is registered to the geometric interpolated model to produce a final interpolated 3D model.

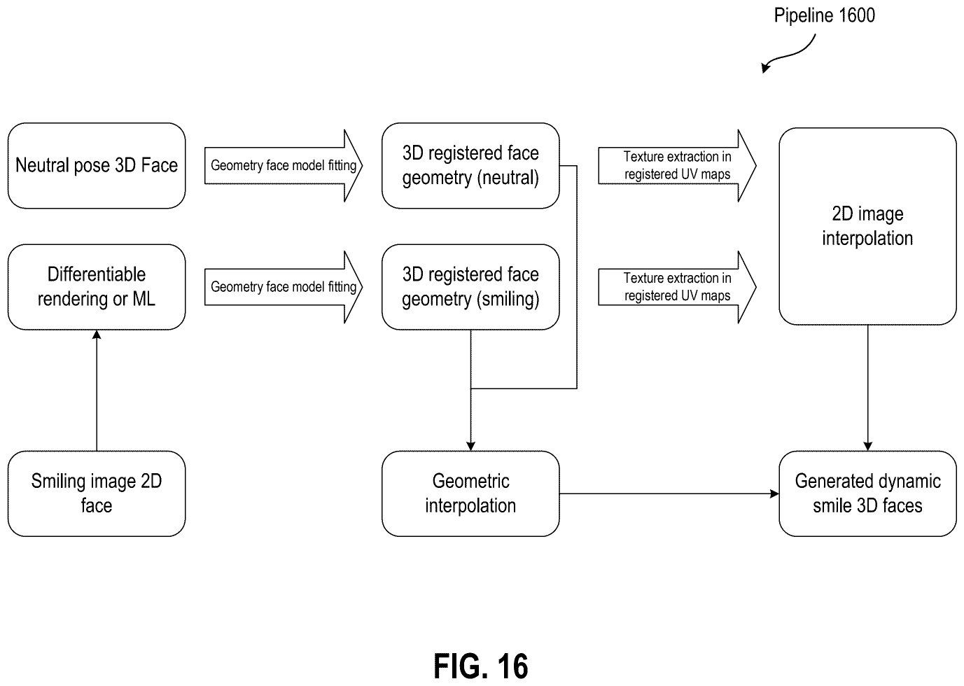

FIG. 16 illustrates an exemplary pipeline 1600, which is a variation of the pipeline 1500, for performing interpolation on 3D models, in accordance with at lease one embodiment. The exemplary pipeline 1600 advantageously performs the functionality of the pipeline 1500 in the situation where no 3D facial scan data of the patient with a wide smile expression exists. In such scenarios, the pipeline 1600 may receive a single 2D image of the patient in a wide smile expression. Differentiable rendering via a trained machine learning model (e.g., differentiable volumetric rendering, such as NeRF modeling) may be applied to generate a 3D skin model representative of the patient's smiling face.

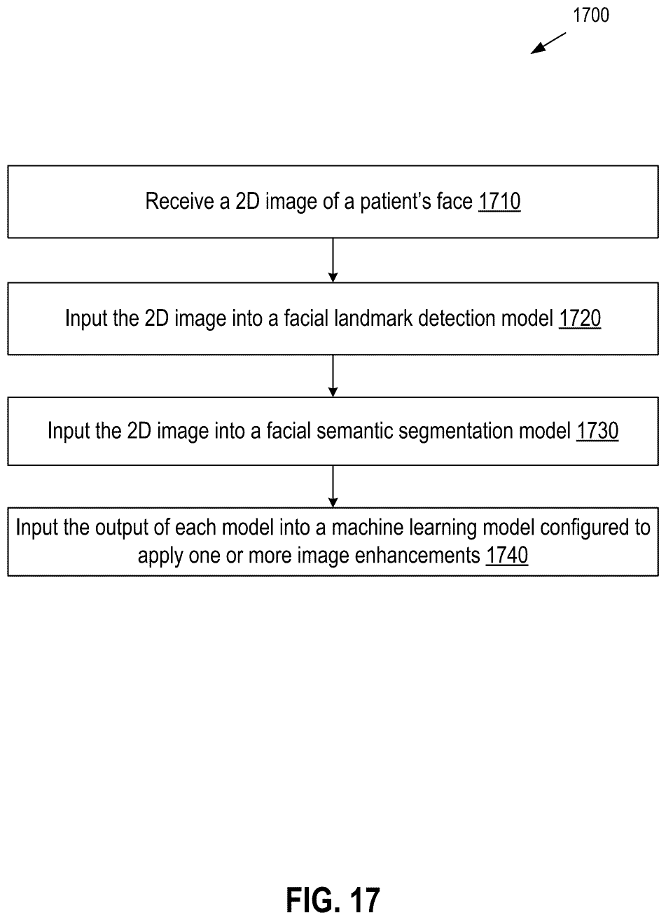

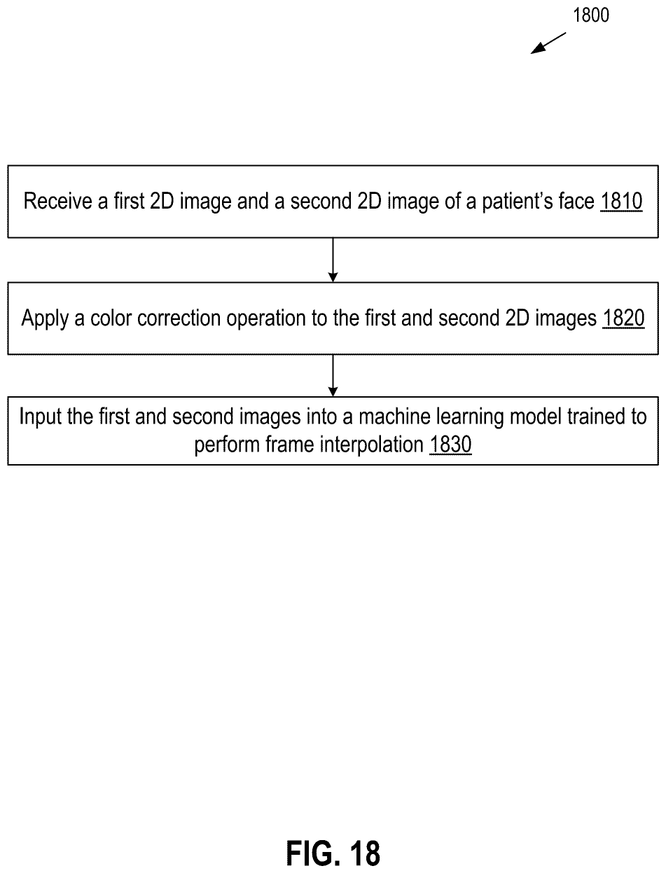

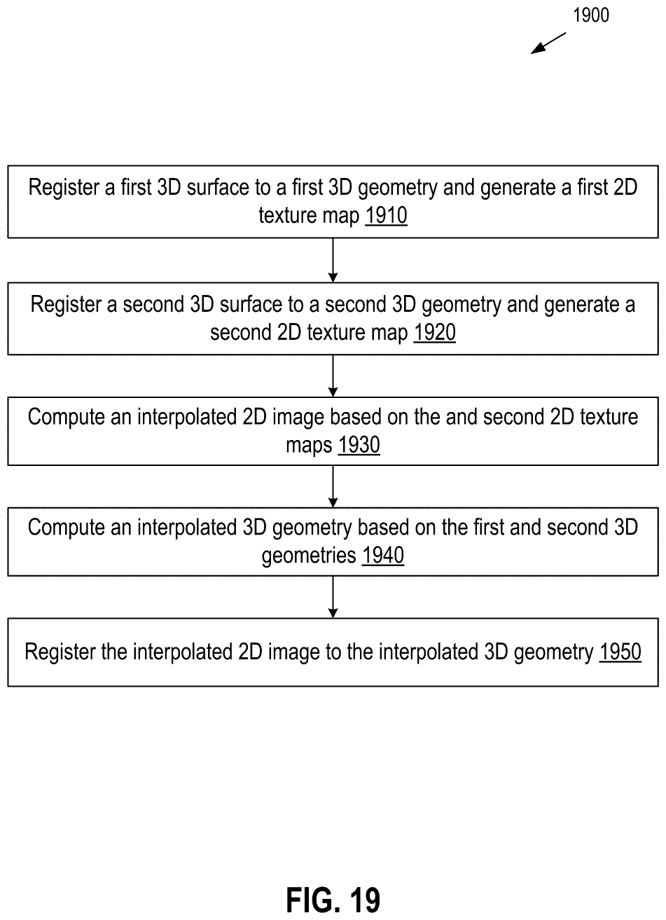

FIG. 17 is a flow diagram illustrating an exemplary method 1700 of enhancing a 2D image of a patient's face, in accordance with at least one embodiment. FIG. 18 is a method of computing an interpolated 2D image based on a first 2D image and a second 2D image of a patient's face, in accordance with at least one embodiment. FIG. 19 is a method of computing an interpolated 3D model based on a first 3D surface and a second 3D surface of a patient's face, in accordance with at least one embodiment. The methods 1700, 1800, and 1900 may be implemented as part of the image enhancement workflow 240, and may be performed by a processing logic that may comprise hardware (e.g., circuitry, dedicated logic, programmable logic, microcode, etc.), software (e.g., instructions run on a processing device to perform hardware simulation), or a combination thereof. In at least one embodiment, at least some operations of the methods 1700, 1800, and 1900 are performed by a computing device executing a dental modeling application, such as the simulation logic 118 of FIG. 1.

Referring to the method 1700 of FIG. 17, at block 1710, the computing device receives at 2D image of a patient's face within which the patient's teeth are visible. In at least one embodiment, the patient in the 2D image is in a wide smile pose for which the patient's teeth are substantially visible. In at least one embodiment, the patient's teeth are not visible within the 2D image.

In at least one embodiment, the 2D image is derived from a photorealistic deformable 3D model of a patient's head computed via differential volumetric rendering (e.g., a 2D rendering of a photorealistic and deformable NeRF or 3DGS model generated from the photorealistic rendering workflow 230).

At block 1720, the computing device inputs the 2D image into a facial landmark detection model (as illustrated in the pipeline 1300).

At block 1730, the computing device inputs the 2D image into a facial semantic segmentation model (as illustrated in the pipeline 1300). In at least one embodiment, blocks 1720 and 1730 are performed in parallel or substantially in parallel.

At block 1740, the computing device inputs the output of each of the facial landmark detection model and the facial semantic segmentation model into a machine learning model. In at least one embodiment, the machine learning model is configured to apply one or more image enhancements. In at least one embodiment, the one or more image enhancements are selected from: face restoration, resolution upscaling, skin smoothing, acne and/or blemish removal, color correction, deblurring, artefact removal, or a combination thereof. In at least one embodiment, the machine learning model outputs an enhanced version of the 2D image.

In at lease one embodiment, the computing device presents for display the enhanced version of the 2D image for visualization of dental treatment planning for the patient.

Referring to the method 1800 of FIG. 18, at block 1810, the computing device receives a first 2D image and a second 2D image of a patient's face. In at least one embodiment, the first 2D image corresponds to the patient's face in a neutral pose and the second 2D image corresponds to the patient's face in a wide smile pose for which the patient's teeth are substantially visible.

At block 1820, the computing device applies a color correction operation to the first 2D image and the second 2D image (as illustrated in the pipeline 1400). In at least one embodiment, the color correction operation causes color balancing between the first 2D image and the second 2D image. In at least one embodiment, the computing device performs a preprocessing operation on the first 2D image and/or the second 2D image prior to inputting into the machine learning model, and optionally prior to applying the color correction operation. In at least one embodiment, the preprocessing operation is an upscaling operation to upscale an image resolution of the first 2D image and/or the second 2D image to match a resolution of training data used to train the machine learning model.

At block 1830, the computing device inputs the first 2D image and the second 2D image into a machine learning model trained to perform frame interpolation (as illustrated in the pipeline 1400). In at least one embodiment, the machine learning model outputs the interpolated 2D image. In at least one embodiment, a degree of interpolation may be user-specified as a continuous value between two endpoints (e.g., from a value of 0 corresponding to the first 2D image to a value of 1 corresponding to the second 2D image).

In at least one embodiment, the interpolated 2D image may be used as the 2D input image to the method 1700 to generate an enhanced version of the interpolated 2D image. For example, the computing device may further input the interpolated 2D image into a facial landmark detection model, input the interpolated 2D image into a facial semantic segmentation model, and input the output of each of the facial landmark detection model and the facial semantic segmentation model into a machine learning model configured to apply one or more image enhancements.

In at least one embodiment, a series of interpolated 2D images may be generated in accordance with the method 1800 at different interpolation positions. The computing device may present for display an animation of the plurality of interpolated 2D images as a continuous series of images between the first 2D image and the second 2D image for visualization of the patient's smile.

Referring to the method 1900 of FIG. 19, at block 1910, the computing device registers a first 3D surface to a first 3D geometry (e.g., a parametric head mesh) and generates a first 2D texture map. In at least one embodiment, the first 3D surface and the first 3D geometry correspond to the patient's face in a neutral pose.

At block 1920, the computing device registers a second 3D surface to a second 3D geometry (e.g., a parametric head mesh) and generates a second 2D texture map. In at least one embodiment, the second 3D surface and the second 3D geometry correspond to the patient's face in a neutral pose in a wide smile pose for which the patient's teeth are substantially visible.

At block 1930, the computing device computes an interpolated 2D image based on the first 2D texture map and the second 2D texture map. For example, the interpolated 2D image may be computed according to method 1800, using the first 2D texture map and the second 2D texture map as inputs to a machine learning model trained to perform frame interpolation.

At block 1940, the computing device computes an interpolated 3D geometry based on the first 3D geometry and the second 3D geometry (as illustrated in the pipeline 1500).

At block 1950, the computing device registers the interpolated 2D image to the interpolated 3D geometry to generate the interpolated 3D model. In at least one embodiment, the computing device presents for display an animation of the interpolated 3D model to show a continuous evolution between the first 3D surface and the second 3D surface for visualization of the patient's smile.

For simplicity of explanation, the methods discussed herein are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events.

The following exemplary embodiments are now described.
Embodiment 1: A method of estimating a three-dimensional (3D) skull model representative of a patient's facial bone structure, the method comprising: receiving, or generating from a facial scan, a 3D skin model representative of an outer surface of the patient's head; generating a combined mesh comprising the 3D skin model and a candidate 3D skull model; generating a reprojected mesh from a trained machine learning model using the combined mesh as input; and generating the 3D skull model by removing the 3D skin model from the reprojected mesh.
Embodiment 2: The method of Embodiment 1, wherein the 3D skin model is generated from the facial scan, and wherein the facial scan is performed by capturing a plurality of two-dimensional (2D) of the patient's face at different orientations with respect to the patient's face.
Embodiment 3: The method of either Embodiment 1 or Embodiment 2, wherein generating the combined mesh comprises registering the 3D skin model with the candidate 3D skull model.
Embodiment 4: The method of Embodiment 3, wherein the registering utilizes facial landmarks to estimate position and orientation of the candidate 3D skull model with respect to the 3D skin model.
Embodiment 5: The method of any one of Embodiments 1-4, wherein using the combined mesh as input comprises generating an input vector comprising a latent space representation of the combined mesh.
Embodiment 6: The method of Embodiment 5, wherein generating the reprojected mesh comprises projecting the latent space representation of the combined mesh into a data space representation.
Embodiment 7: The method of any one of Embodiments 1-6, further comprising: receiving aligned intraoral scan data representative of the patient's upper and lower dental arches, wherein generating the reprojected mesh based at least in part on the aligned intraoral scan data.
Embodiment 8: The method of Embodiment 7, further comprising: non-rigidly deforming the 3D skull model to conform its shape and alignment with the upper and lower dental arches of the aligned intraoral scan data.
Embodiment 9: The method of Embodiment 8, further comprising: non-rigidly deforming the 3D skull model to reduce intersections with the 3D skin model.
Embodiment 10: The method of any one of Embodiments 1-9, further comprising receiving additional data sets for input to the machine learning model, the additional data sets comprising one or more of panoramic X-ray scan data, cephalometric X-ray scan data, magnetic resonance imaging scan data, partial cone beam computed tomography scan data, or articulation capture data.
Embodiment 11: The method of any one of Embodiments 1-10, further comprising: integrating the 3D skull model with one or more data sets or processes for use in visualization of a dental treatment plan for the patient.
Embodiment 12: The method of any one of Embodiments 1-11, further comprising: generating a volumetric mesh representative of soft tissue of a virtual patient's head based on the 3D skin model and the 3D skull model, wherein the volumetric mesh can be used with physically-based simulation techniques to simulate deformations and predict changes to soft tissue of the virtual patient's face responsive to a dental treatment plan.
Embodiment 13: The method of Embodiment 12, further comprising: generating an additional rigid mesh representative of teeth; and simulating teeth-to-teeth contact to predict changes to the virtual patient's bite and resulting soft and hard tissue changes responsive to the dental treatment plan.
Embodiment 14: The method of Embodiment 12, further comprising: generating additional anatomical constraints in the temporomandibular area of the virtual patient's jaw to simulate changes to the virtual patient's bite and the resulting soft and hard tissue changes responsive to the dental treatment plan.
Embodiment 15: The method of Embodiment 12, further comprising: simulating the dynamic occlusion jaw motion of the virtual patient based on teeth-to-teeth modeling.
Embodiment 16: The method of Embodiment 15, further comprising: generating additional anatomical constraints in the temporomandibular area of the virtual patient's jaw to provide a better informed simulated dynamic occlusion jaw motion of the virtual patient.
Embodiment 17: A method of estimating a three-dimensional (3D) skull model representative of a patient's facial bone structure, the method comprising: receiving, or generating from a facial scan, a 3D skin model representative of an outer surface of the patient's head; projecting the 3D skin model into a learned skin latent space; applying a learned mapping from skin latent code to skull latent code to compute the corresponding coordinates in a learned skull latent space; and reprojecting the skull latent space coordinates back to the 3D skull model.
Embodiment 18: A method of estimating a three-dimensional (3D) skull model representative of a patient's facial bone structure, the method comprising: receiving, or generating from a facial scan, a 3D skin model representative of an outer surface of the patient's head; determining skin-bone model latent code by computing a fit according to a specified loss; and generating the 3D skull model from optimized joint skin-bone model fit.
Embodiment 19: A method of training a machine learning model to predict skull structure of a patient based on a 3D skin model representative of an outer surface of the patient's skin, the method comprising: providing a plurality of data sets as training data, each data set corresponding to a particular patient and comprising at least a 3D skin model representative of an outer surface of the patient's skin and a 3D skull model representative of the patient's skull, wherein, during inference, the trained machine learning model is configured to compute a 3D skull model in response to a 3D skin model as input.
Embodiment 20: The method of Embodiment 19, further comprising: for each of the plurality of data sets, registering the 3D skin model to its corresponding 3D skull model.
Embodiment 21: The method of either Embodiment 18 or Embodiment 19, wherein, for at least one of the data sets, the 3D skull model comprises or is derived from cone beam computed tomography (CBCT) scan data.
Embodiment 22: The method of Embodiment 21, wherein, for at least one of the data sets, the 3D skin model and the 3D skull model are derived from the same CBCT scan data based on a segmentation process.
Embodiment 23: The method of any one of Embodiments 19-22, wherein, for at least one skin-skull-teeth pairs data set, the 3D skull model comprises or is derived from cone beam computed tomography and intraoral scan data.
Embodiment 24: The method of any one of Embodiments 19-23, wherein the machine learning model comprises a supervised machine learning model to determine mappings between bone structure data and skin data derived from the plurality of data sets.
Embodiment 25: The method of any one of Embodiments 19-24, wherein at least one of the plurality of data sets further comprises aligned intraoral scan data for the corresponding patient.
Embodiment 26: The method of any one of Embodiments 19-25, further comprising: generating using each of the plurality of data sets as an input vector comprising a latent space representation of the 3D skin model and corresponding 3D skull model.
Embodiment 27: The method of any one of Embodiments 19-26, further comprising receiving additional CBCT scan data and intraoral scan data for input, wherein the CBCT scan data is segmented and fused with the intraoral scan data.
Embodiment 28: The method of Embodiment 27, further comprising: applying a deformation to deform the 3D skull model in areas sufficiently covered by the partial CBCT scan data.
Embodiment 29: The method of Embodiment 28, wherein the 3D skin model is extracted from a 3D facial scan of the patient that is registered to the input intraoral scan.
Embodiment 30: A method of training a parametric head model that can be used with an optimization-based method to reconstruct a 3D skull model based on a patient's lateral cephalometric scan, wherein, during optimization, the parametric head model is fitted to an input cephalometric scan, and wherein joint head model latent code is optimized such that a rendered lateral/frontal projection is fitted to the input cephalometric scan.
Embodiment 31: The method of Embodiment 30, wherein the rendered lateral/frontal projection is further fitted to an input intraoral scan.
Embodiment 32: A system for estimating a three-dimensional (3D) skull model representative of a patient's facial bone structure, the system comprising: a memory; and a processing device operatively coupled to the memory, wherein the processing device is configured to perform the method of any one of Embodiments 1-31.
Embodiment 33: A non-transitory machine-readable medium having instructions encoded thereon that, when executed by a processing device, cause the processing device to perform the method of any one of Embodiments 1-31.
Embodiment 34: A method of generating a volumetric mesh representative of soft tissue of a patient's head, the method comprising: receiving, or generating from a facial scan, a 3D skin model representative of an outer surface of the patient's head; receiving intraoral scan data comprising a 3D teeth model representative of the patient's teeth and gingiva structure; receiving a 3D skull model representative of the patient's skull structure; generating, based at least partially on the 3D skin model, the 3D skull model, and the 3D teeth model, an initial unloaded volumetric mesh representative of an unloaded state of soft tissue of the patient's head under no teeth-soft contact or no gravitational load; and performing differentiable simulation-based optimization to optimize the unloaded volumetric mesh.
Embodiment 35: The method of Embodiment 34, wherein the initial unloaded volumetric mesh is representative of the unloaded state of the soft tissue of the patient's head under no gravitational load.
Embodiment 36: The method of either Embodiment 34 or Embodiment 35, wherein the initial unloaded volumetric mesh is representative of the unloaded state of the soft tissue of the patient's head under no teeth-soft contact and no gravitational load.
Embodiment 37: The method of any one of Embodiments 34-36, wherein the 3D skull model comprises or is derived from cone beam computed tomography (CBCT) scan data.
Embodiment 38: The method of any one of Embodiments 34-37, wherein the 3D skull model is derived from the 3D skin model.
Embodiment 39: The method of Embodiment 38, wherein deriving the 3D skull model from the 3D skin model comprises: generating a combined mesh comprising the 3D skin model and a candidate 3D skull model; generating a reprojected mesh from a trained machine learning model using the combined mesh as input; and generating the 3D skull model by removing the 3D skin model from the reprojected mesh.
Embodiment 40: The method of any one of Embodiments 34-39, wherein simulating the initial volumetric mesh in the unloaded state comprises applying one or more of differential analysis or a finite element solver to the initial volumetric mesh.
Embodiment 41: The method of Embodiment 40, wherein simulating the initial volumetric mesh in the unloaded state further comprises: generating a plurality of candidate volumetric meshes based on the initial volumetric mesh that are representative of a soft tissue of the patient's head under no teeth-soft contact and no gravitational load; and selecting, based on the differential analysis or finite element solver, a candidate volumetric mesh as the unloaded volumetric mesh.
Embodiment 42: The method of any one of Embodiments 34-41, further comprising: wherein the volumetric mesh is deformable to simulate and predict changes to the patient's face responsive to a dental treatment plan.
Embodiment 43: The method of any one of Embodiments 34-42, further comprising: receiving intraoral scan data for the patient representative of upper and lower dental arches of the patient; and registering the intraoral scan data to the 3D skull model prior to generating the initial volumetric mesh.
Embodiment 44: The method of any one of Embodiments 34-43, further comprising: receiving predicted intraoral scan data representative of predicted tooth positions for the upper and lower dental arches after implementing a treatment plan for the patient; generating a predicted 3D skull model by registering the predicted intraoral scan data to the 3D skull model; and registering the unloaded volumetric mesh to the predicted 3D skull model.
Embodiment 45: The method of any one of Embodiments 34-44, further comprising: simulating the registered free volumetric mesh under loaded conditions to predict a post-treatment shape of the outer surface of the patient's head after implementing the treatment plan.
Embodiment 46: The method of any one of Embodiments 34-45, wherein the volumetric mesh is deformable to simulate and predict changes to the patient's face responsive to simulations of bone growth, aging, or weight gain or loss.
Embodiment 47: The method of any one of Embodiments 34-46, wherein the volumetric mesh is deformable to simulate and predict changes to the patient's face responsive to aesthetic treatments.
Embodiment 48: The method of any one of Embodiments 34-47, wherein the initial volumetric mesh is further representative of stiffness variations in the soft tissue of the patient's head.
Embodiment 49: The method of any one of Embodiments 34-48, further comprising generating a photorealistic deformable 3D model of the patient's head based on differential volumetric rendering.
Embodiment 50: A system for generating a volumetric mesh representative of soft tissue of a patient's head, the system comprising: a memory; and a processing device operatively coupled to the memory, wherein the processing device is configured to perform the method of any one of Embodiments 34-49.
Embodiment 51: A non-transitory machine-readable medium having instructions encoded thereon that, when executed by a processing device, cause the processing device to perform the method of any one of Embodiments 34-49.
Embodiment 52: A method of generating a photorealistic deformable 3D model of a patient's head via differentiable volumetric rendering modeling, the method comprising: receiving a plurality of two-dimensional (2D) images of the patient's head in different orientations; generating a differentiable volumetric rendering model based on the plurality of 2D images; and generating the photorealistic deformable 3D model based at least in part on the differentiable volumetric rendering model.
Embodiment 53: The method of Embodiment 52, wherein the differential volumetric rendering model has an associated visualization space, and wherein the method further comprises: generating an aligned differential volumetric rendering model by aligning the differential volumetric rendering model with a deformable mesh representative of the patient's head, the aligned differential volumetric rendering model having an associated deformation space.
Embodiment 54: The method of Embodiment 53, wherein the photorealistic deformable 3D model is generated based further on the aligned differential volumetric rendering model, and wherein the photorealistic deformable 3D model has associated therewith the visualization space and the deformation space.
Embodiment 55: The method of any one of Embodiments 52-54, further comprising: generating an initial 3D mesh from the plurality of 2D images via photogrammetry; and generating the deformable mesh by fitting a pre-defined model derived from a database of aligned 3D scans of human faces.
Embodiment 56: The method of any one of Embodiments 52-55, further comprising: generating an initial 3D mesh from a volumetric mesh representative of soft tissue of a patient's head; and generating the deformable mesh by fitting a pre-defined model derived from a database of aligned 3D scans of human faces.
Embodiment 57: The method of Embodiment 55, further comprising: training a volumetric radiance field learning model based on the deformable mesh, wherein generating the differential volumetric rendering model based on the plurality of 2D images comprises obtaining the differential volumetric rendering model from trained volumetric radiance fields or 3D Gaussian splats.
Embodiment 58: The method of any one of Embodiments 52-57, wherein generating the differential volumetric rendering model comprises utilizing an NeRF architecture comprising a cascading series of multilayer-perceptron (MLP) architectures.
Embodiment 59: The method of Embodiment 58, wherein the cascading series of MLP architectures comprises: a deformation-based MLP architecture representative of deformation space; a density-based MLP architecture representative of density space; and a color-based MLP architecture representative of color map space.
Embodiment 60: The method of any one of Embodiments 52-59, wherein the plurality of 2D images are obtained from a video of the patient's head in the different orientations.
Embodiment 61: The method of any one of Embodiments 52-60, wherein the plurality of 2D images comprises at least about 50 images of the patient's head.
Embodiment 62: The method of any one of Embodiments 52-61, further comprising: generating a predicted differential volumetric rendering model based at least in part on a predicted 3D skin model of the patient's head computed based on a simulation of a dental treatment plan; and generating a predicted photorealistic deformable 3D model based at least in part on the predicted differential volumetric rendering model.
Embodiment 63: The method of any one of Embodiments 52-62, wherein teeth of the patient are visible within the plurality of 2D images, and wherein the photorealistic deformable 3D model is deformable based on simulated displacements in the teeth.
Embodiment 64: The method of any one of Embodiments 52-63, further comprising: presenting, for display by a display device, a real-time interactive volumetric rendering of the photorealistic deformable 3D model for visualization.
Embodiment 65: A system for generating a photorealistic deformable 3D model of a patient's head via differential volumetric rendering modeling, the system comprising: a memory; and a processing device operatively coupled to the memory, wherein the processing device is configured to perform the method of any one of Embodiments 52-64.
Embodiment 66: A non-transitory machine-readable medium having instructions encoded thereon that, when executed by a processing device, cause the processing device to perform the method of any one of Embodiments 52-64.
Embodiment 67: A method of enhancing a two-dimensional (2D) image of a patient's face, the method comprising: receiving the 2D image of the patient's face, wherein the patient's teeth are visible in the image; inputting the 2D image into a facial landmark detection model; inputting the 2D image into a facial semantic segmentation model; and inputting the output of each of the facial landmark detection model and the facial semantic segmentation model into a machine learning model configured to apply one or more image enhancements, wherein the machine learning model outputs an enhanced version of the 2D image.
Embodiment 68: The method of Embodiment 67, further comprising: presenting for display the enhanced version of the 2D image for visualization of dental treatment planning for the patient.
Embodiment 69: The method of either Embodiment 67 or 68, wherein the one or more image enhancements are selected from: face restoration, resolution upscaling, skin smoothing, acne and/or blemish removal, color correction, deblurring, artefact removal, or a combination thereof.
Embodiment 70: The method of any one of Embodiments 67-69, wherein the patient in the 2D image is in a wide smile pose for which the patient's teeth are substantially visible.
Embodiment 71: The method of any one of Embodiments 67-70, wherein the 2D image is derived from a photorealistic deformable 3D model of a patient's head computed via differentiable volumetric rendering modeling.
Embodiment 72: The method of Embodiment 71, wherein the differentiable volumetric rendering modeling comprises a neural radiance field (NeRF)-based method or a 3D Gaussian splatting-based method.
Embodiment 73: A system for enhancing a two-dimensional (2D) image of a patient's face, the system comprising: a memory; and a processing device operatively coupled to the memory, wherein the processing device is configured to perform the method of any one of Embodiments 67-72.
Embodiment 74: A non-transitory machine-readable medium having instructions encoded thereon that, when executed by a processing device, cause the processing device to perform the method of any one of Embodiments 67-72.
Embodiment 75: A method of computing an interpolated 2D image based on a first 2D image and a second 2D image of a patient's face, the method comprising: applying a color correction operation to the first 2D image and the second 2D image to perform color balancing between the first 2D image and the second 2D image, wherein the first 2D image corresponds to the patient's face in a neutral pose and the second 2D image corresponds to the patient's face in a wide smile pose for which the patient's teeth are substantially visible; and subsequently inputting the first 2D image and the second 2D image into a machine learning model trained to perform frame interpolation, wherein the output of the machine learning model comprises the interpolated 2D image.
Embodiment 76: The method of Embodiment 75, further comprising: inputting the interpolated 2D image into a facial landmark detection model; inputting the interpolated 2D image into a facial semantic segmentation model; and inputting the output of each of the facial landmark detection model and the facial semantic segmentation model into a machine learning model configured to apply one or more image enhancements, wherein the machine learning model outputs an enhanced version of the interpolated 2D image.
Embodiment 77: The method of either Embodiment 75 or Embodiment 76, further comprising: performing a preprocessing operation on the first 2D image and/or the second 2D image prior to inputting into the machine learning model.
Embodiment 78: The method of Embodiment 77, wherein the preprocessing operation is an upscaling operation, and wherein the upscaling operation is to upscale an image resolution of the first 2D image and/or the second 2D image to match a resolution of training data used to train the machine learning model.
Embodiment 79: A method of generating a series of interpolated 2D images generating a plurality of interpolated 2D images at different interpolation positions, wherein each of the plurality of interpolated 2D images is generated according to the method of any one of Embodiments 75-78.
Embodiment 80: The method of Embodiment 79, further comprising: presenting for display an animation of the plurality of interpolated 2D images as a continuous series of images between the first 2D image and the second 2D image for visualization of the patient's smile.
Embodiment 81: A system for computing an interpolated 2D image based on a first 2D image and a second 2D image of a patient's face, the system comprising: a memory; and a processing device operatively coupled to the memory, wherein the processing device is configured to perform the method of any one of Embodiments 75-80.
Embodiment 82: A non-transitory machine-readable medium having instructions encoded thereon that, when executed by a processing device, cause the processing device to perform the method of any one of Embodiments 75-80.
Embodiment 83: A method of computing an interpolated three-dimensional (3D) model based on a first 3D surface and a second 3D surface of a patient's face, the method comprising: registering the first 3D surface to a first 3D geometry and generating a first 2D texture map, the first 3D surface and first 3D geometry corresponding to the patient's face in a neutral pose; registering the second 3D surface to a second 3D geometry and generating a second 2D texture map, the second 3D surface and second 3D geometry corresponding to the patient's face in a wide smile pose for which the patient's teeth are substantially visible; computing an interpolated 2D image based on the first 2D texture map and the second 2D texture map; computing an interpolated 3D geometry based on the first 3D geometry and the second 3D geometry; and registering the interpolated 2D image to the interpolated 3D geometry to generate the interpolated 3D model.
Embodiment 84: The method of Embodiment 83, wherein computing the interpolated 2D image comprises inputting the first 2D texture map and the second 2D texture map into a machine learning model trained to perform frame interpolation, wherein the output of the machine learning model comprises the interpolated 2D image.
Embodiment 85: The method of either Embodiment 83 or Embodiment 84, further comprising: presenting for display an animation of the interpolated 3D model to show a continuous evolution between the first 3D surface and the second 3D surface for visualization of the patient's smile.
Embodiment 86: A system for computing an interpolated 2D image based on a first 2D image and a second 2D image of a patient's face, the system comprising: a memory; and a processing device operatively coupled to the memory, wherein the processing device is configured to perform the method of any one of Embodiments 83-85.
Embodiment 87: A non-transitory machine-readable medium having instructions encoded thereon that, when executed by a processing device, cause the processing device to perform the method of any one of Embodiments 83-85.

FIG. 20 illustrates a diagrammatic representation of a machine in the example form of a computing device 2000 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The computing device 2000 may correspond, for example, to computing device 105 and/or computing device 106 of FIG. 1. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 2000 includes a processing device 2002, a main memory 2004 (e.g., read-only memory (ROM), flash memory, dynamic random access memory (DRAM) such as synchronous DRAM (SDRAM), etc.), a static memory 2006 (e.g., flash memory, static random access memory (SRAM), etc.), and a secondary memory (e.g., a data storage device 2028), which communicate with each other via a bus 2008.

Processing device 2002 represents one or more general-purpose processors such as a microprocessor, central processing unit, or the like. More particularly, the processing device 2002 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 2002 may also be one or more special-purpose processing devices such as an application specific integrated circuit (ASIC), a field programmable gate array (FPGA), a digital signal processor (DSP), network processor, or the like. Processing device 2002 is configured to execute the processing logic (instructions 2026) for performing operations and steps discussed herein.

The computing device 2000 may further include a network interface device 2022 for communicating with a network 2064. The computing device 2000 also may include a video display unit 2010 (e.g., a liquid crystal display (LCD) or a cathode ray tube (CRT)), an alphanumeric input device 2012 (e.g., a keyboard), a cursor control device 2014 (e.g., a mouse), and a signal generation device 2020 (e.g., a speaker).

The data storage device 2028 may include a machine-readable storage medium (or more specifically a non-transitory computer-readable storage medium) 2024 on which is stored one or more sets of instructions 2026 embodying any one or more of the methodologies or functions described herein, such as instructions for dental modeling logic 116. A non-transitory storage medium refers to a storage medium other than a carrier wave. The instructions 2026 may also reside, completely or at least partially, within the main memory 2004 and/or within the processing device 2002 during execution thereof by the computer device 2000, the main memory 2004 and the processing device 2002 also constituting computer-readable storage media.

The computer-readable storage medium 2024 may also be used to store dental modeling logic 116, which may include one or more machine learning modules, and which may perform the operations described herein above. The computer readable storage medium 2024 may also store a software library containing methods for the dental modeling logic 116. While the computer-readable storage medium 2024 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium other than a carrier wave that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

While the present disclosure is described with respect to the specific application of dental evaluation for humans, the present disclosure is not limited thereto. The techniques described herein can equally be applied to any other medical applications. For example, techniques described can be utilized for imaging generally, and in particular for imaging and characterizing elements of human or animal anatomy such as eyes, nose, other facial elements, bone structures, etc.

Claim language or other language herein reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method of estimating a three-dimensional (3D) skull model representative of a patient's facial bone structure, the method comprising:
receiving, or generating from a facial scan, a 3D skin model representative of an outer surface of the patient's head;
generating a combined mesh comprising the 3D skin model and a candidate 3D skull model;
generating a reprojected mesh from a trained machine learning model using the combined mesh as input; and
generating the 3D skull model by removing the 3D skin model from the reprojected mesh.

2. The method of claim 1, wherein the 3D skin model is generated from the facial scan, and wherein the facial scan is performed by capturing a plurality of two-dimensional (2D) of the patient's face at different orientations with respect to the patient's face.

3. The method of claim 1, wherein generating the combined mesh comprises registering the 3D skin model with the candidate 3D skull model, and wherein the registering utilizes facial landmarks to estimate position and orientation of the candidate 3D skull model with respect to the 3D skin model.

4. The method of claim 1, wherein using the combined mesh as input comprises generating an input vector comprising a latent space representation of the combined mesh, and wherein generating the reprojected mesh comprises projecting the latent space representation of the combined mesh into a data space representation.

5. The method of claim 1, further comprising:
receiving aligned intraoral scan data representative of the patient's upper and lower dental arches, wherein generating the reprojected mesh based at least in part on the aligned intraoral scan data; and
non-rigidly deforming the 3D skull model to conform its shape and alignment with the upper and lower dental arches of the aligned intraoral scan data.

6. The method of claim 1, further comprising receiving additional data sets for input to the machine learning model, the additional data sets comprising one or more of panoramic X-ray scan data, cephalometric X-ray scan data, magnetic resonance imaging scan data, partial cone beam computed tomography scan data, or articulation capture data.

7. The method of claim 1, further comprising:
integrating the 3D skull model with one or more data sets or processes for use in visualization of a dental treatment plan for the patient.

8. The method of claim 1, further comprising:
generating a volumetric mesh representative of soft tissue of a virtual patient's head based on the 3D skin model and the 3D skull model, wherein the volumetric mesh can be used with physically-based simulation techniques to simulate deformations and predict changes to soft tissue of the virtual patient's face responsive to a dental treatment plan.

9. The method of claim 8, further comprising:
simulating the dynamic occlusion jaw motion of the virtual patient based on teeth-to-teeth modeling; and
generating additional anatomical constraints in the temporomandibular area of the virtual patient's jaw to provide a better informed simulated dynamic occlusion jaw motion of the virtual patient.

10. A system for estimating a three-dimensional (3D) skull model representative of a patient's facial bone structure, the system comprising:
a memory; and
a processing device operatively coupled to the memory, wherein the processing device is configured to perform the method of claim 1.

11. A non-transitory machine-readable medium having instructions encoded thereon that, when executed by a processing device, cause the processing device to perform the method of claim 1.

12. A method of estimating a three-dimensional (3D) skull model representative of a patient's facial bone structure, the method comprising:
receiving, or generating from a facial scan, a 3D skin model representative of an outer surface of the patient's head;
projecting the 3D skin model into a learned skin latent space;
applying a learned mapping from skin latent code to skull latent code to compute the corresponding coordinates in a learned skull latent space; and
reprojecting the skull latent space coordinates back to the 3D skull model.

13. A method of estimating a three-dimensional (3D) skull model representative of a patient's facial bone structure, the method comprising:
receiving, or generating from a facial scan, a 3D skin model representative of an outer surface of the patient's head;
determining skin-bone model latent code by computing a fit according to a specified loss; and
generating the 3D skull model from optimized joint skin-bone model fit.

14. A method of training a machine learning model to predict skull structure of a patient based on a 3D skin model representative of an outer surface of the patient's skin, the method comprising:
providing a plurality of data sets as training data, each data set corresponding to a particular patient and comprising at least a 3D skin model representative of an outer surface of the patient's skin and a 3D skull model representative of the patient's skull,
wherein, during inference, the trained machine learning model is configured to compute a 3D skull model in response to a 3D skin model as input.

15. A method of training a parametric head model that can be used with an optimization-based method to reconstruct a 3D skull model based on a patient's lateral cephalometric scan, wherein, during optimization, the parametric head model is fitted to an input cephalometric scan, and wherein joint head model latent code is optimized such that a rendered lateral/frontal projection is fitted to the input cephalometric scan.

16. A method of generating a volumetric mesh representative of soft tissue of a patient's head, the method comprising:
receiving, or generating from a facial scan, a 3D skin model representative of an outer surface of the patient's head;
receiving intraoral scan data comprising a 3D teeth model representative of the patient's teeth and gingiva structure;
receiving a 3D skull model representative of the patient's skull structure;
generating, based at least partially on the 3D skin model, the 3D skull model, and the 3D teeth model, an initial unloaded volumetric mesh representative of an unloaded state of soft tissue of the patient's head under no teeth-soft contact or no gravitational load; and
performing differentiable simulation-based optimization to optimize the unloaded volumetric mesh.

17. A method of generating a photorealistic deformable 3D model of a patient's head via differentiable volumetric rendering modeling, the method comprising:
receiving a plurality of two-dimensional (2D) images of the patient's head in different orientations;
generating a differentiable volumetric rendering model based on the plurality of 2D images; and
generating the photorealistic deformable 3D model based at least in part on the differentiable volumetric rendering model.

18. A method of enhancing a two-dimensional (2D) image of a patient's face, the method comprising:
receiving the 2D image of the patient's face, wherein the patient's teeth are visible in the image;
inputting the 2D image into a facial landmark detection model;
inputting the 2D image into a facial semantic segmentation model; and
inputting the output of each of the facial landmark detection model and the facial semantic segmentation model into a machine learning model configured to apply one or more image enhancements, wherein the machine learning model outputs an enhanced version of the 2D image.

19. A method of computing an interpolated 2D image based on a first 2D image and a second 2D image of a patient's face, the method comprising:
applying a color correction operation to the first 2D image and the second 2D image to perform color balancing between the first 2D image and the second 2D image, wherein the first 2D image corresponds to the patient's face in a neutral pose and the second 2D image corresponds to the patient's face in a wide smile pose for which the patient's teeth are substantially visible; and
subsequently inputting the first 2D image and the second 2D image into a machine learning model trained to perform frame interpolation, wherein the output of the machine learning model comprises the interpolated 2D image.

20. A method of computing an interpolated three-dimensional (3D) model based on a first 3D surface and a second 3D surface of a patient's face, the method comprising:
registering the first 3D surface to a first 3D geometry and generating a first 2D texture map, the first 3D surface and first 3D geometry corresponding to the patient's face in a neutral pose;
registering the second 3D surface to a second 3D geometry and generating a second 2D texture map, the second 3D surface and second 3D geometry corresponding to the patient's face in a wide smile pose for which the patient's teeth are substantially visible;
computing an interpolated 2D image based on the first 2D texture map and the second 2D texture map;
computing an interpolated 3D geometry based on the first 3D geometry and the second 3D geometry; and
registering the interpolated 2D image to the interpolated 3D geometry to generate the interpolated 3D model.
